(19) United States
(12) Patent Application Publication
(10) Pub. No.: US 2015/0298924 A1
(43) Pub. Date: Oct. 22, 2015

(54) SHEET FEEDING DEVICE AND IMAGE FORMING APPARATUS

(71) Applicant: CANON KABUSHIKI KAISHA, Tokyo (JP)

(72) Inventors: Takeshi Matoba, Yokohama-shi (JP); Masashige Tamura, Kawasaki-shi (JP)

(21) Appl. No.: 14/683,514

(22) Filed: Apr. 10, 2015

(30) Foreign Application Priority Data
Apr. 22, 2014 (JP) 2014-088232

(51) Int. Cl. B65H 3/06; B65H 7/20; B65H 7/02; G03G 15/00; B65H 1/14

(52) U.S. Cl. CPC B65H 3/0684; G03G 15/6529; B65H 1/14; B65H 7/02; B65H 7/20

(57) ABSTRACT

A sheet feeding device includes: a tip end holding portion configured to hold a tip end of the fed sheet at a first position on the downstream side in the sheet feeding direction in relation to a separation portion; a guide portion configured to guide the sheet; a movement unit configured to move the tip end holding portion and the guide portion between the first position and a second position closer to a feeding portion in relation to the first position; a release portion configured to release the sheet held by the tip end holding portion when the tip end holding portion moves from the first position to the second position; and a conveying portion configured to convey the sheet released from the tip end holding portion at the second position and convey the sheet in an area near the feeding portion in relation to the first position.

### BACKGROUND OF THE INVENTION

1. Field of the Invention

The present invention relates to a sheet feeding device used in an image forming apparatus such as a copying machine, a facsimile machine, and a printer and an image forming apparatus including the same.

2. Description of the Related Art

Hitherto, an image forming apparatus such as a copying machine generally has a configuration in which a sheet cassette is set at a lower portion of an apparatus body and an image forming portion is disposed at the upside thereof. Accordingly, for example, as disclosed in U.S. Patent Application Publication No. 2010/226669 A1, a sheet feeding device used in an image forming apparatus forms a sheet conveying path so that a sheet substantially horizontally stacked on a stacking portion is pressed in the horizontal direction by a roller member from the rear side and is conveyed in the vertical direction. Accordingly, the sheet is conveyed to the image forming portion located above the stacking portion.

As described above, in a case where the sheet which is fed in the horizontal direction is conveyed in the vertical direction, there is a need to provide a conveying path having a curvature radius suitable for the stiffness of the sheet in order to reduce the stress of the sheet tip end. Then, the curvature radius needs to be increased as the stiffness of the sheet becomes stronger.

For that reason, the sheet feeding device needs to be protruded in the horizontal direction by the dimension of the curvature radius or more from the sheet stacking position. Since the protrusion portion directly influences the installation area of the device, this protrusion portion disturbs a design of the device which is attachable to a small space due to the small size thereof.

### SUMMARY OF THE INVENTION

The invention provides a sheet feeding device capable of reducing an installation space and an image forming apparatus including the same.

A sheet feeding device of the invention includes: a feeding portion configured to feed sheets stacked on a stacking portion; a separation portion configured to separate the sheets fed by the feeding portion one by one; a tip end holding portion configured to hold a tip end of the sheet fed by the feeding portion at a first position on the downstream side in the sheet feeding direction in relation to the separation portion; a guide portion configured to guide the sheet fed by the feeding portion; a movement unit configured to move the tip end holding portion and the guide portion between the first position and a second position closer to the feeding portion in relation to the first position; a holding release portion configured to release the sheet held by the tip end holding portion that holds the sheet tip end when the tip end holding portion moves from the first position to the second position; and a conveying portion configured to convey the sheet released from the tip end holding portion at the second position and fed by the feeding portion and convey the sheet in an area near the feeding portion in relation to the first position.

Since the sheet fed by the feeding portion is held at the tip end thereof at the first position on the downstream side of the separation portion, is returned to the second position which is closer to the feeding portion than the first position while the tip end is held, and is fed to the conveying portion thereafter, the protrusion amount from the stacking portion in the sheet feeding direction may be decreased as small as possible. For this reason, it is possible to decrease the size of the device and to reduce the installation space thereof.

Further features of the present invention will become apparent from the following description of exemplary embodiments with reference to the attached drawings.

### BRIEF DESCRIPTION OF THE DRAWINGS

FIG. 1 is a diagram illustrating an overall configuration of an image forming apparatus;

FIG. 2 is a diagram in which a sheet feeding device is viewed from the right front up direction;

FIG. 3 is a diagram in which a movable feeding guide unit is viewed from the right front up direction;

FIG. 4 is a diagram in which the movable feeding guide unit is viewed from the right back up direction;

FIG. 5 is a diagram in which the movable feeding guide unit is viewed from the right back down direction;

FIG. 6 is a diagram in which the movable feeding guide unit is viewed from the left direction;

FIGS. 7A to 7C are diagrams illustrating the movable feeding guide unit, where FIG. 7A is a diagram in which the movable feeding guide unit is viewed from the front direction, FIG. 7B is a diagram in which the movable feeding guide unit is viewed from the right direction, and FIG. 7C is a diagram in which the movable feeding guide unit is viewed from the down direction;

FIGS. 8A and 8B are diagrams illustrating the movable feeding guide unit, where FIG. 8A is a diagram in which the movable feeding guide unit is viewed from the back direction and FIG. 8B is a diagram in which the movable feeding guide unit is viewed from the up direction;

FIG. 9 is a diagram in which a main frame unit is viewed from the right front up direction;

FIG. 10 is a diagram in which the periphery of a cassette box is viewed from the left front up direction;

FIG. 11 is a diagram in which the periphery of the cassette box is viewed from the right front up direction;

FIGS. 12A and 12B are diagrams illustrating a motor unit, where FIG. 12A is a diagram in which the motor unit is viewed from the right front up direction and FIG. 12B is a diagram in which the motor unit is viewed from the left front up direction;

FIGS. 13A to 13C are diagrams illustrating a left cam gear, where FIG. 13A is a diagram in which the left cam gear is viewed from the left direction, FIG. 13B is a diagram in which the left cam gear is viewed from the front direction, and FIG. 13C is a diagram in which the left cam gear is viewed from the right direction;

FIGS. 14A to 14C are diagrams illustrating a right cam gear, where FIG. 14A is a diagram in which the right cam gear is viewed from the left direction, FIG. 14B is a diagram in which the right cam gear is viewed from the front direction, and FIG. 14C is a diagram in which the right cam gear is viewed from the right direction;

FIG. 15 is a diagram illustrating a positional relation among a left trigger lever, a cam gear, and a feeding gear;

FIG. 16 is a diagram illustrating a positional relation among a right trigger lever, a cam gear, and a feeding gear;

FIG. 17 is a diagram illustrating a positional relation between a right feeding gear and a link disk;

FIG. 18 is a diagram in which a feeding roller is viewed from the front direction;

FIG. 19 is a diagram in which a triggering component is viewed from the right back up direction;

FIG. 20 is a diagram in which a right release cam presses a sheet supporting plate as much as possible;

FIG. 21 is a diagram in which the periphery of a movable guide is viewed from the right front up direction;

FIG. 22 is a diagram in which the periphery of the movable guide is viewed from the right back direction;

FIG. 23 is a cross-sectional view in which the periphery of a sheet tip end holding portion and an inner guide are viewed from the right direction;

FIG. 24 is a cross-sectional view in which a left switch portion is viewed from the right direction;

FIG. 25 is a diagram in which a left movable guide posture changing unit is viewed from the right direction;

FIG. 26 is a diagram in which the movable guide posture changing unit is viewed from the right front direction;

FIGS. 27A and 27B are a chart illustrating the operation timing of a main component;

FIG. 28 is a cross-sectional view illustrating a state where a sheet feeding operation performed by a feeding rubber roller starts when viewed from the right direction;

FIG. 29 is a cross-sectional view illustrating a state where the sheet feeding operation performed by the feeding rubber roller is completed when viewed from the right direction;

FIG. 30 is a cross-sectional view illustrating a state where the sheet tip end holding portion is opened at a second position;

FIG. 31 is a cross-sectional view illustrating a change in posture while the movable guide moves in a reciprocating manner between the first position and the second position when viewed from the right direction; and

FIG. 32 is a diagram illustrating a state where a route of a sheet conveying path is changed to the inside of an apparatus compared to the related art after a sheet is picked up.

### DESCRIPTION OF THE EMBODIMENTS

Next, a sheet feeding device according to an embodiment of the invention and an image forming apparatus including the same will be described with reference to the drawings.

### First Embodiment

### Overall Configuration of Image Forming Apparatus

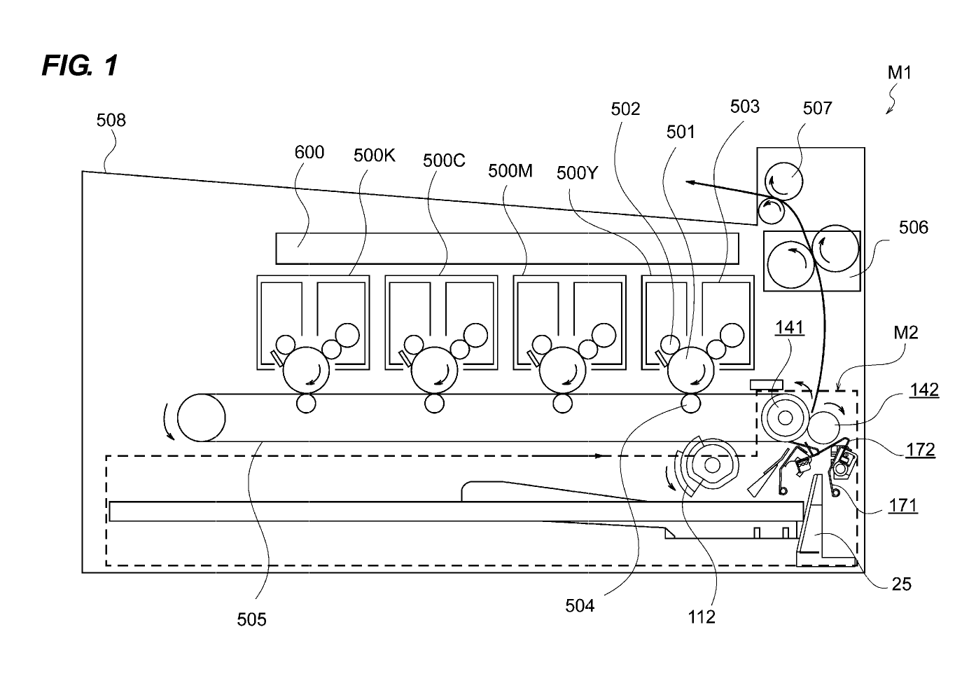

FIG. 1 is an entire schematic diagram illustrating an image forming apparatus including a sheet feeding device according to an embodiment of the invention. An image forming apparatus M1 of the embodiment has a configuration in which four image forming portions 500Y, 500M, 500C, and 500K forming images of yellow, magenta, cyan, and black are disposed. The image forming portions have the same configuration except that only the color of the toner forming the image is different. For example, the image forming portion will be described by exemplifying the yellow image forming portion 500Y.

In order to form an image, a photosensitive drum 501 is rotationally driven, and the surface thereof is charged by a charging roller 502. Then, a laser scanner unit 600 emits a laser beam from a light source (not illustrated) provided therein, and irradiates the photosensitive drum with the laser beam. Accordingly, a latent image is formed on the surface of the photosensitive drum 501. When the latent image is developed by a development device 503, a toner image is formed on the photosensitive drum 501. The toner image which is formed on the photosensitive drum 501 is primarily transferred onto an intermediate transfer belt 505 while a transfer bias is applied to a transfer roller 504. When the toner images of different colors are transferred sequentially from the yellow, magenta, cyan, and black image forming portions to the rotating intermediate transfer belt 505, a color image is formed on the belt.

During the image forming operation, a sheet is fed from a sheet feeding device M2 to a nip between a pair of conveying rollers 141 and 142 serving as a secondary transfer portion. When the sheet is conveyed by the pair of conveying rollers, the color toner image which is transferred onto the intermediate transfer belt 505 is transferred onto the sheet by the application of the transfer bias to the roller 142 serving as a secondary transfer roller. Then, the sheet onto which the toner image is transferred is heated and pressed in a fixing portion 506 so that the toner image is fixed onto the sheet, and then is discharged to a discharging portion 508 by a pair of discharge rollers 507.

### <Sheet Feeding Device>

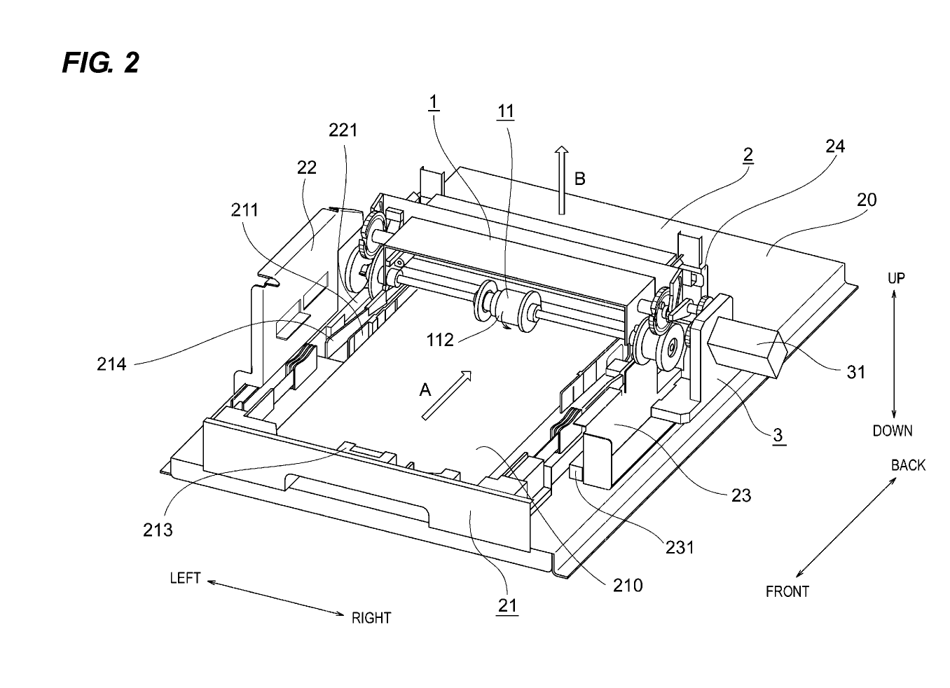

Next, the sheet feeding device M2 will be described. FIG. 2 is a diagram in which the sheet feeding device M2 is viewed from the right front up direction. Furthermore, the front to back direction, the left and right direction, and the up and down direction of the apparatus mentioned herein are respectively indicated by the arrows in FIG. 2. The sheet feeding device M2 of the embodiment includes a movable feeding guide unit 1, a main frame unit 2, and a motor unit 3.

In the description below, the schematic function and the schematic configuration of each unit will be described first. Next, the detailed configuration of each component will be described. Finally, the detailed step in the continuous operation will be described.

### (Movable Feeding Guide Unit)

An uppermost sheet 210 which is stacked on a cassette box 21 is fed by a feeding rubber roller 112. The sheet feeding direction corresponds to the direction indicated by the backward arrow A, and the rotation direction of the feeding rubber roller 112 corresponds to the counter-clockwise direction when viewed from the right direction.

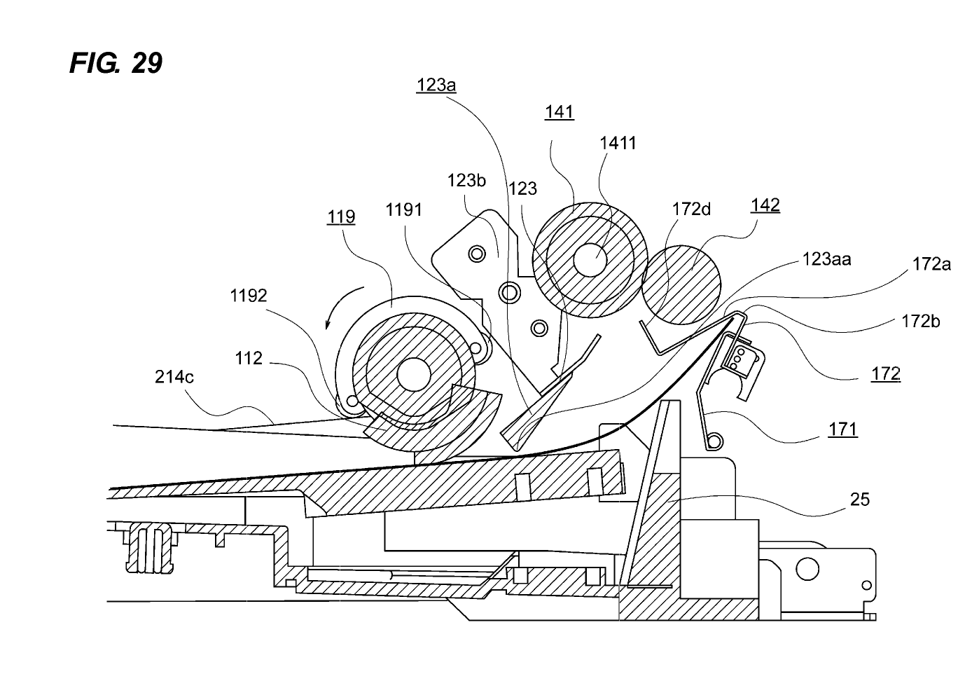

The sheet feeding device of the embodiment feeds the sheets picked up by the feeding rubber roller 112 as a sheet feeding portion while the sheets are separated one by one by a slope separation portion 25 (see FIG. 29). At this time, the sheet is fed while having a predetermined curvature. Then, the tip end of the fed sheet is held by a sheet tip end holding portion 172 (see FIG. 29) which is located at a first position at the downstream side of the slope separation portion in the sheet feeding direction while waiting for the upcoming sheet. Then, the sheet tip end holding portion 172 is returned to a second position which is located near the feeding rubber roller 112 in relation to the first position and is located in the vicinity of a nip 14a of a pair of conveying rollers 14 while the sheet is held by the sheet tip end holding portion, and the held sheet is released. Accordingly, the sheet which is fed in a separated state is returned. That is, the sheet is fed to a secondary transfer portion by the pair of conveying rollers 14 in a manner such that the sheet is fed by the feeding rubber roller 112 again to the nip 14a.

Accordingly, although the sheet is fed while having a predetermined curvature until the sheet is separated, the sheet may be fed along a substantially perpendicular route formed from the feeding rubber roller 112 to the pair of conveying rollers 14. Meanwhile, the sheet tip end holding portion 172 is returned from the second position to the first position in the meantime, and waits at the first position so as to pick up the next sheet.

A schematic configuration of the movable feeding guide unit 1 that feeds the sheet as described above will be described.

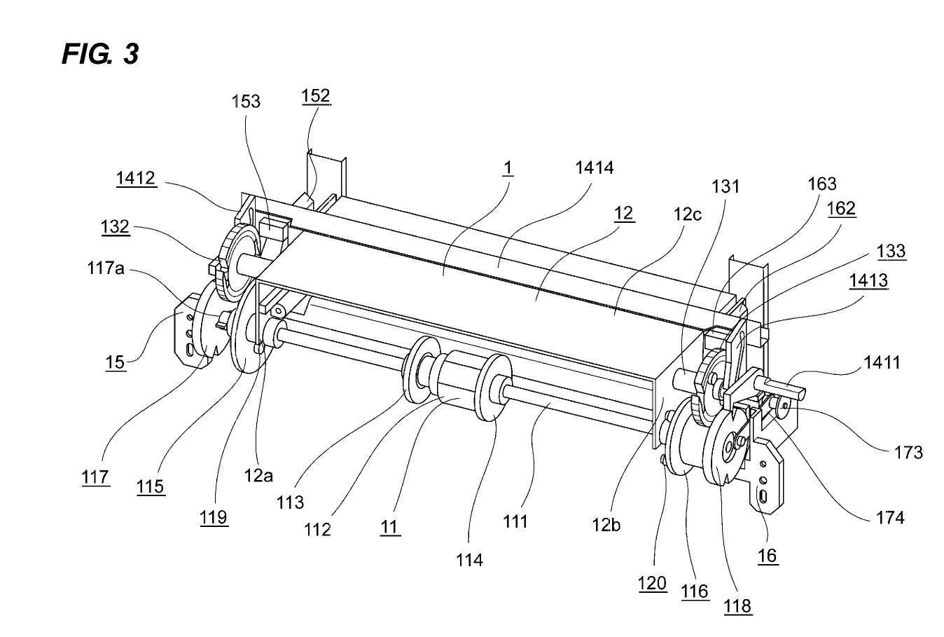

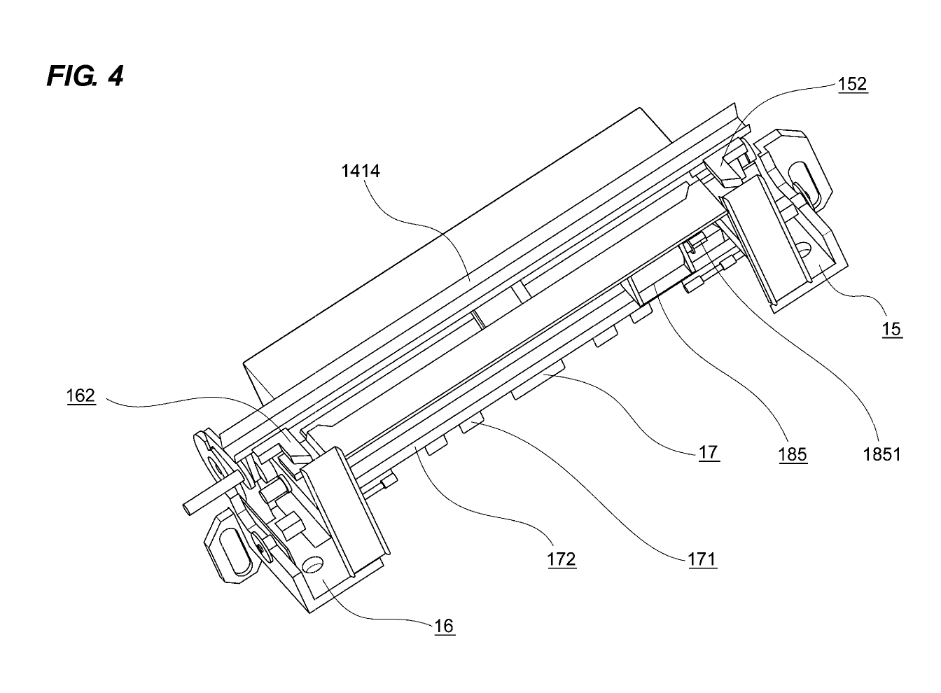

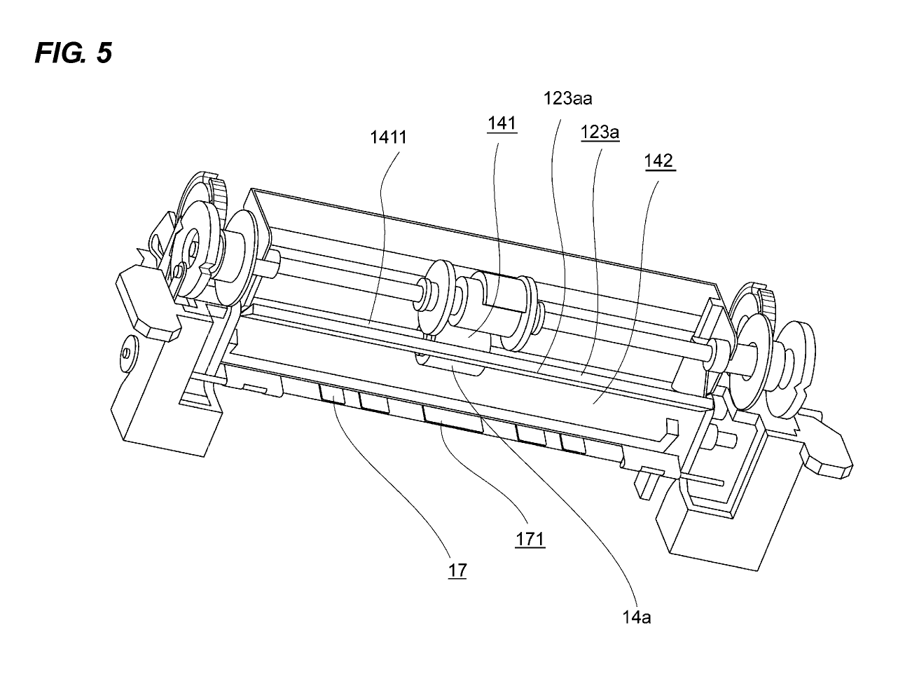

FIG. 3 is a diagram in which the movable feeding guide unit 1 is viewed from the right front up direction, and FIG. 4 is a diagram in which the movable feeding guide unit 1 is viewed from the right back up direction. Further, FIG. 5 is a diagram in which the movable feeding guide unit 1 is viewed from the right back down direction.

As illustrated in FIG. 3, a frame 12 includes a left frame portion 12a which is bent in the left down direction, a right frame portion 12b which is bent in the right down direction, and a horizontal frame portion 12c which connects the left and right frames 12a and 12b to each other.

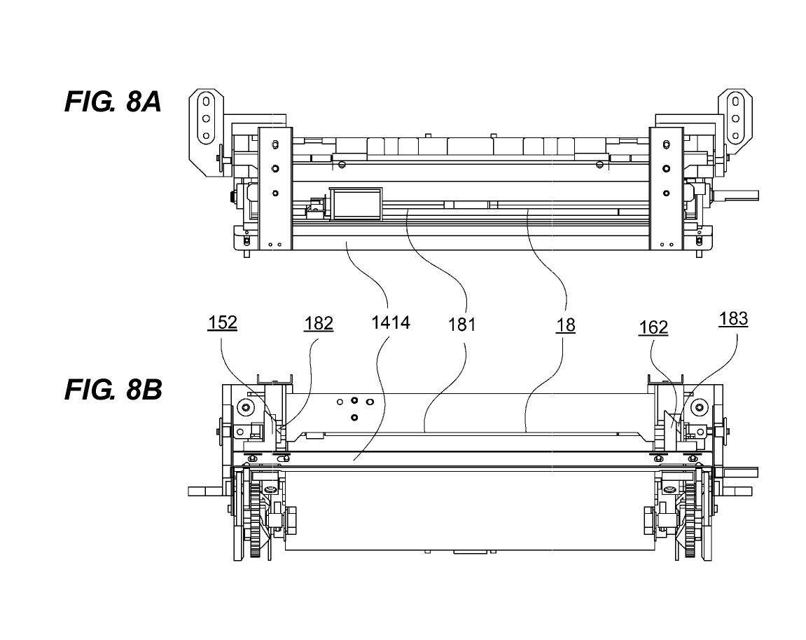

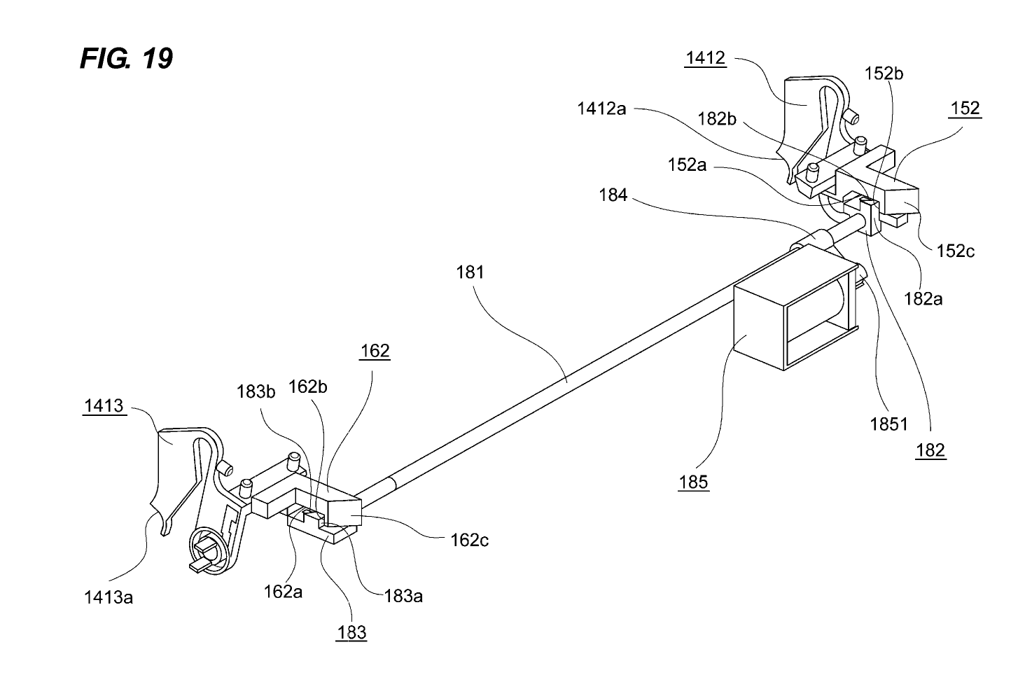

A feeding shaft 111 which serves as a rotation shaft for a feeding roller 11, a cam gear shaft 131 which serves as a rotation shaft for cam gears 132 and 133, and a roller shaft 1411 which serves as a rotation shaft for one inner conveying roller 141 of the pair of conveying rollers 14 are rotatably supported between the left and right frames 12a and 12b. Further, as illustrated in FIG. 4, a trigger shaft 181 (see FIG. 8) is provided between the left and right frames 12a and 12b, and is rotatably supported by the left and right frames. The trigger shaft 181 is used to rotate triggers 182 and 183 (see FIG. 19), which cause trigger rods 152 and 162 provided at the left and right sides of the feeding device to start to move forward by a biasing spring (not illustrated), together in the left and right direction.

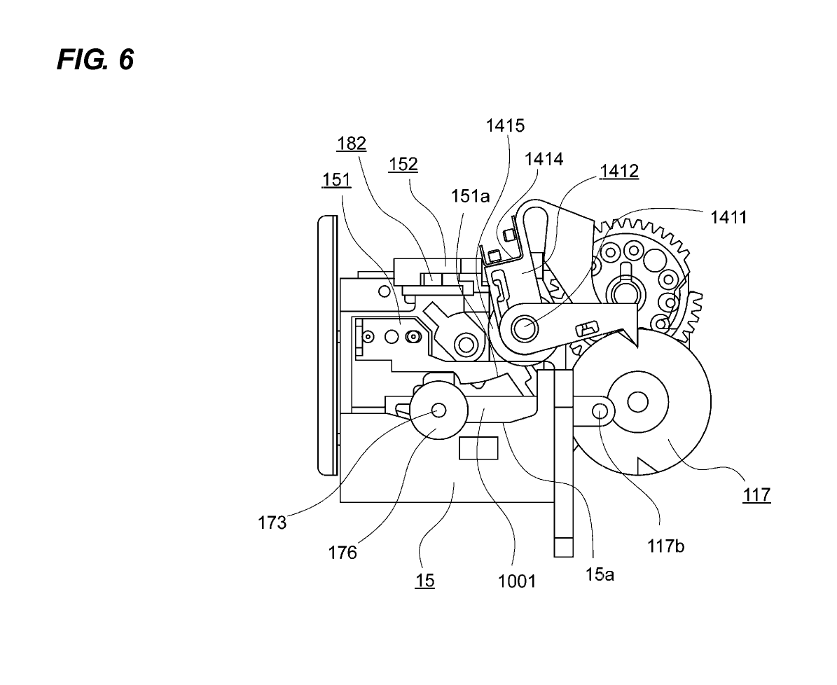

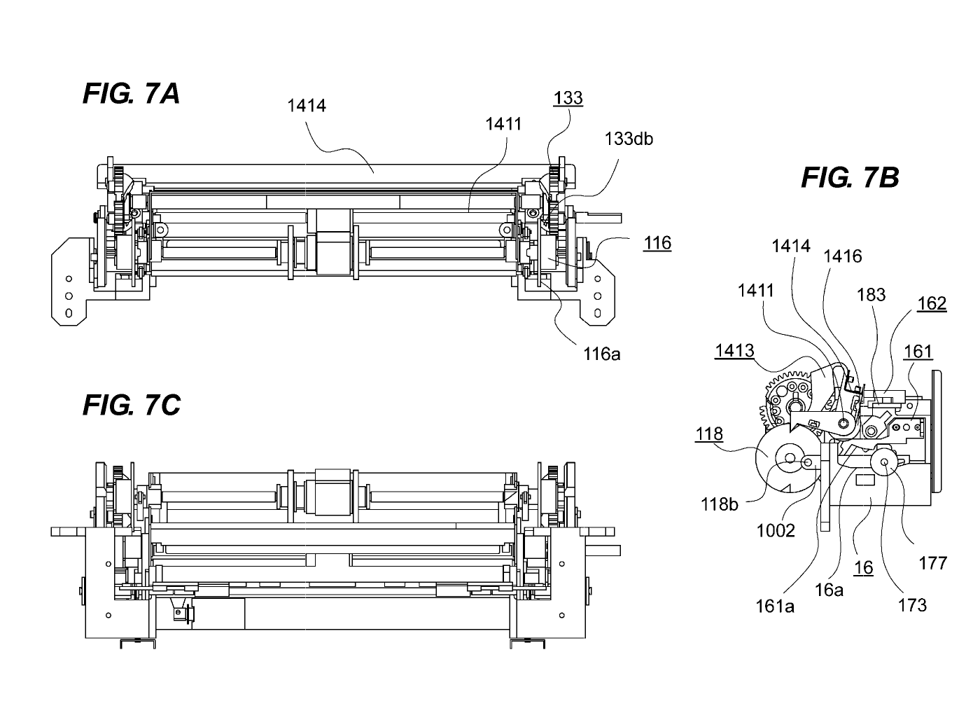

Further, as illustrated in FIGS. 6 to 7C, the inner conveying roller shaft 1411 also serves as a rotation shaft for trigger levers 1412 and 1413 for triggering the cam gears 132 and 133 in order to control the ON/OFF rotation state of the feeding roller 11. The inner conveying roller shaft 1411 also serves as a rotation shaft for inner conveying roller gears 1415 and 1416 which engage with the cam gears 132 and 133 in order to transmit the driving force generated by a main motor 31 to the cam gears 132 and 133.

Furthermore, mold frames 15 and 16 are respectively coupled to the left frame portion 12a and the right frame portion 12b from the left and right direction.

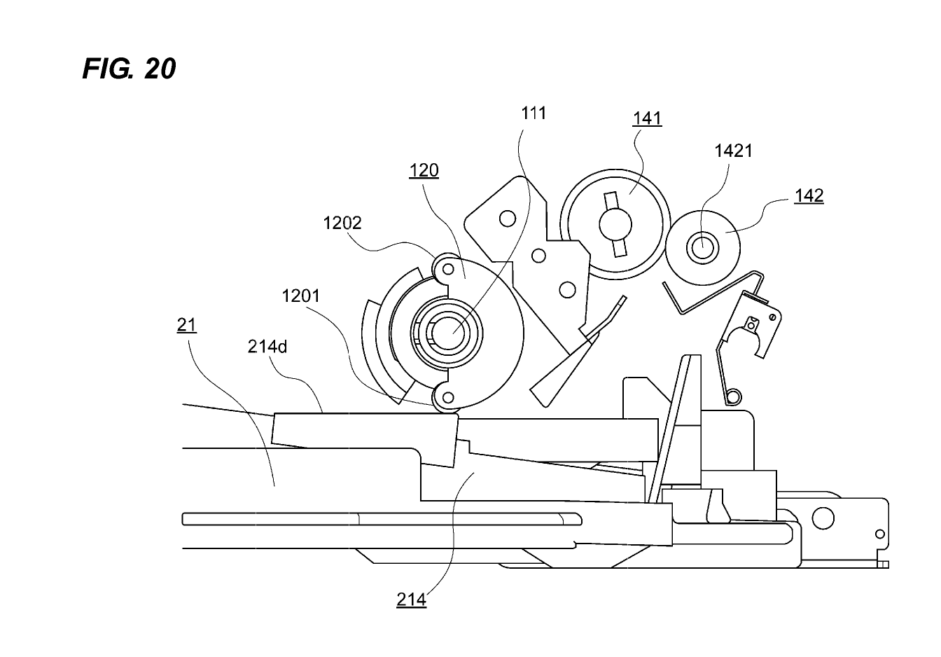

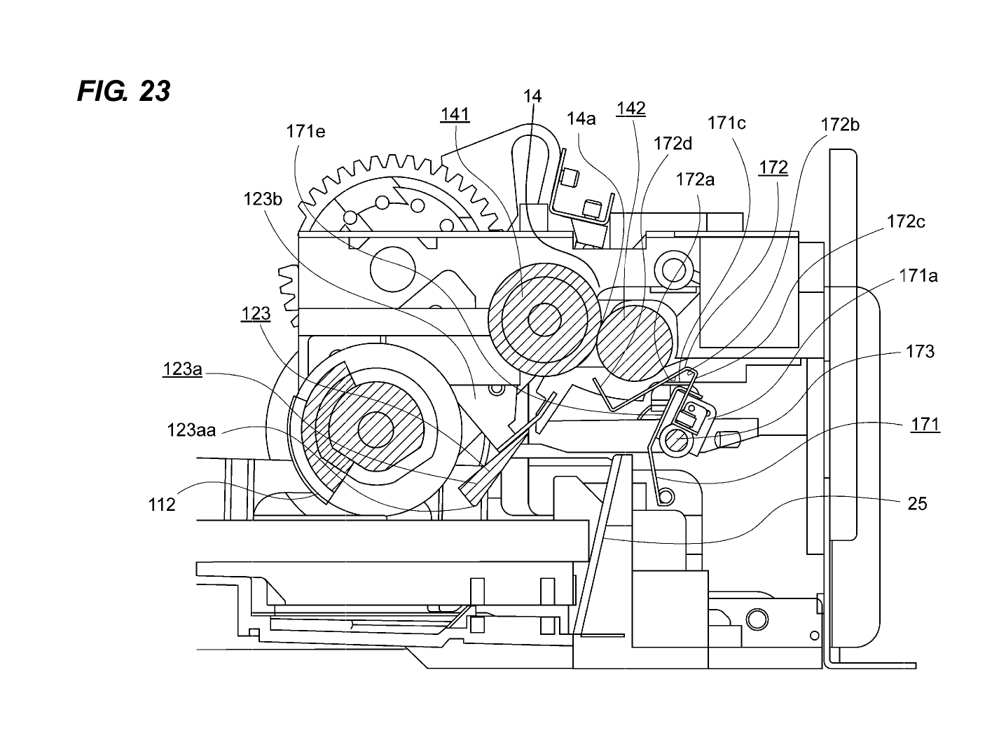

The pair of conveying rollers 14 are formed by pressing the outer conveying roller 142 (see FIG. 23) to the inner conveying roller 141, and the outer conveying roller shaft 1421 (see FIG. 20) is rotatably supported by the left and right mold frames 15 and 16 while connecting the left and right mold frames to each other.

Further, as illustrated in FIGS. 6 to 8B, posture changing guides 151 and 161 which change the posture of a movable guide 17 are respectively attached to the left and right mold frames 15 and 16. Further, the trigger rods 152 and 162 are respectively attached to the left and right mold frames 15 and 16 in a slidable manner.

### (Main Frame Unit)

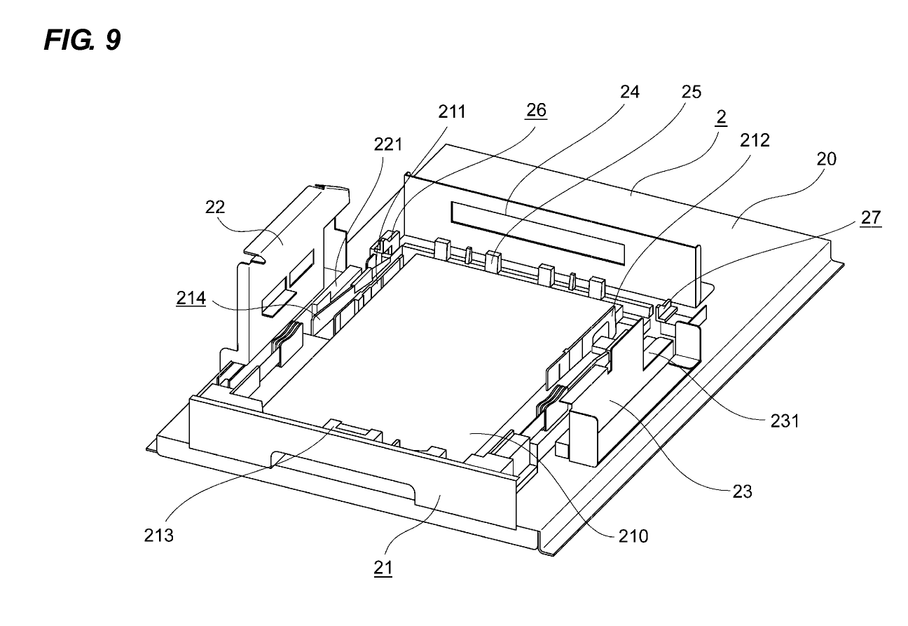

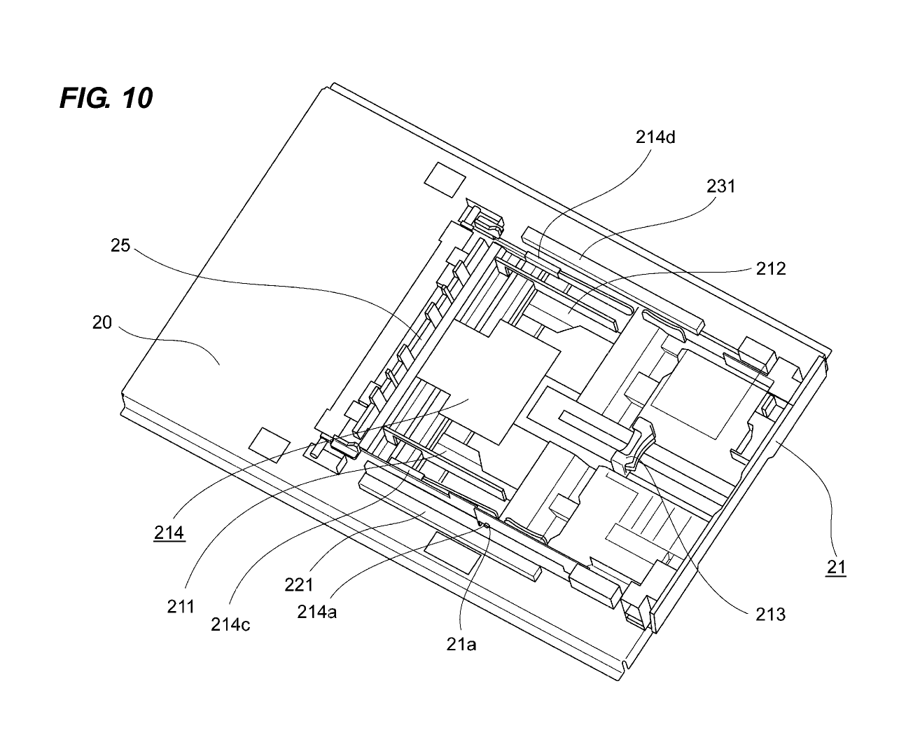

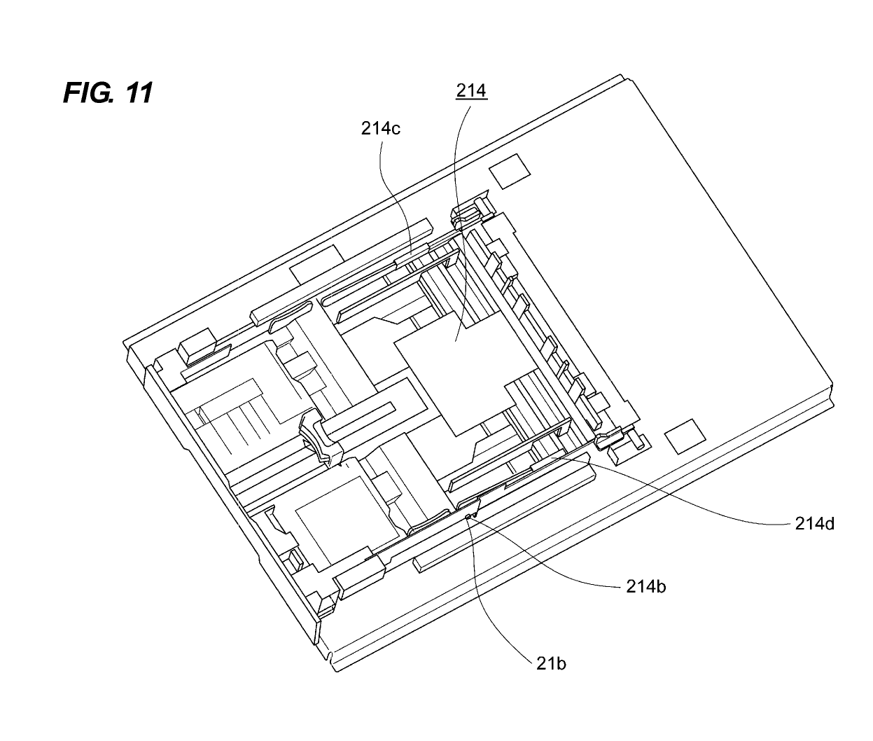

FIG. 9 is a diagram in which the main frame unit 2 is viewed from the right front up direction, FIG. 10 is a diagram in which the periphery of the cassette box 21 is viewed from the left front up direction, and FIG. 11 is a diagram in which the periphery of the cassette box 21 is viewed from the right front up direction.

The movable feeding guide unit 1 is supported by a left plate 22, a right plate 23, and a rear plate 24 which are uprightly formed in a base frame 20. Here, the sheet which is fed by the feeding roller 11 is positioned in each of the front to back direction, the left and right direction, and the up and down direction. In order to feed the sheet by the feeding roller 11, the uppermost sheet 210 is pressed against the feeding roller 11 by a sheet supporting plate 214 at the lower side of the sheet stacked on the cassette box 21. At this time, the motor unit 3 is supported by the base frame 20.

The position of the cassette box 21 for stacking the sheet thereon in the front to back direction is determined in a manner such that the cassette box 21 abuts against the rear bottom of the slope separation portion 25 uprightly formed in the base frame 20. The position of the cassette box in the left and right direction is determined in a manner such that the cassette box 21 is sandwiched by a guide member 221 provided in the left plate 22 so as to extend in the front to back direction and a guide member 231 provided in the right plate 23 so as to extend in the front to back direction while having a minute gap in the left and right direction. Here, the cassette box 21 may be attached or detached while being slid in the longitudinal direction (the front to back direction) of the guide members 221 and 231.

The position of the sheet accommodated in the cassette box 21 in the left and right direction is determined in a manner such that the sheet is sandwiched by width regulation plates 211 and 212 adapted to be slidable in the left and right direction while a small pressure is applied to both ends of the sheet. When the sliding positions of the width regulation plates 211 and 212 are changed, various sheet widths may be handled. The position of the sheet in the front to back direction is determined in a manner such that a tail end regulation block 213 adapted to be slidable in the front to back direction is slightly pressed against the sheet tail end while the front side of the sheet slightly abuts against the bottom of the slope separation portion 25.

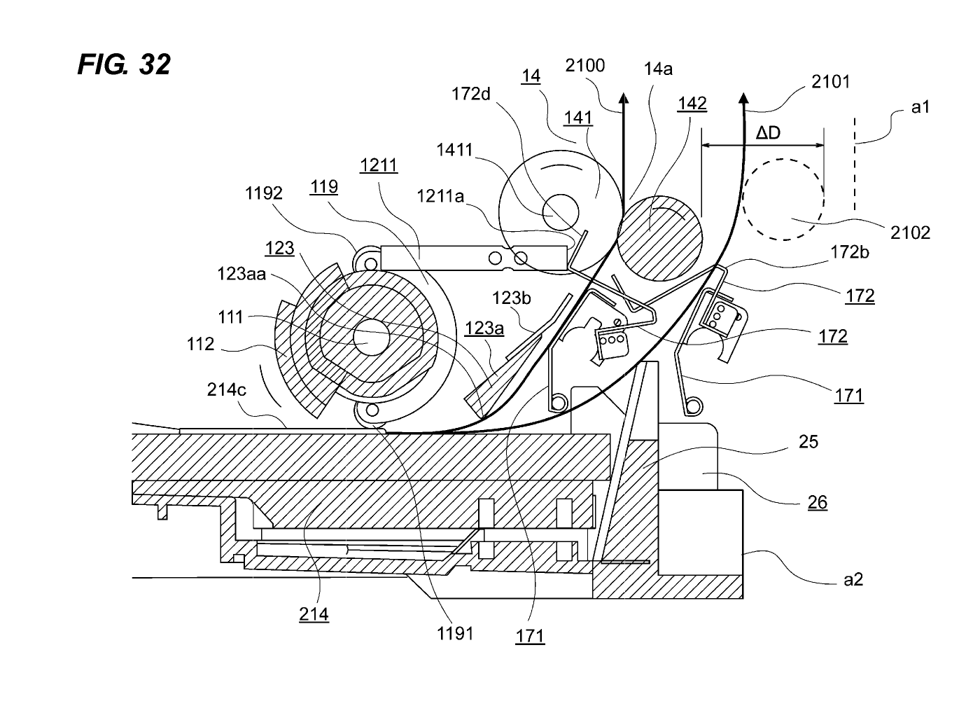

As illustrated in FIGS. 10 and 11, the sheet supporting plate 214 is disposed so that boss portions 214a and 214b existing at both left and right ends are rotatably supported while being fitted to holes 21a and 21b of the cassette box 21. Further, the sheet supporting plate 214 is biased upward by a biasing spring (not illustrated), and the uppermost sheet of the sheets stacked on the sheet supporting plate 214 may be pressed against the feeding roller 11 or may be separated from the feeding roller in accordance with the rotation positions of release cams 119 and 120 (see FIGS. 20 and 32).

The slope separation portion 25 is fixed to the base frame 20. The slope separation portion 25 has a function of separating one sheet from a plurality of sheets supplied by the feeding roller 11. Further, movable guide posture changing units 26 and 27 are fixed to the base frame 20 so that the movable guide 17 smoothly returns from the second position to the first position.

### (Motor Unit)

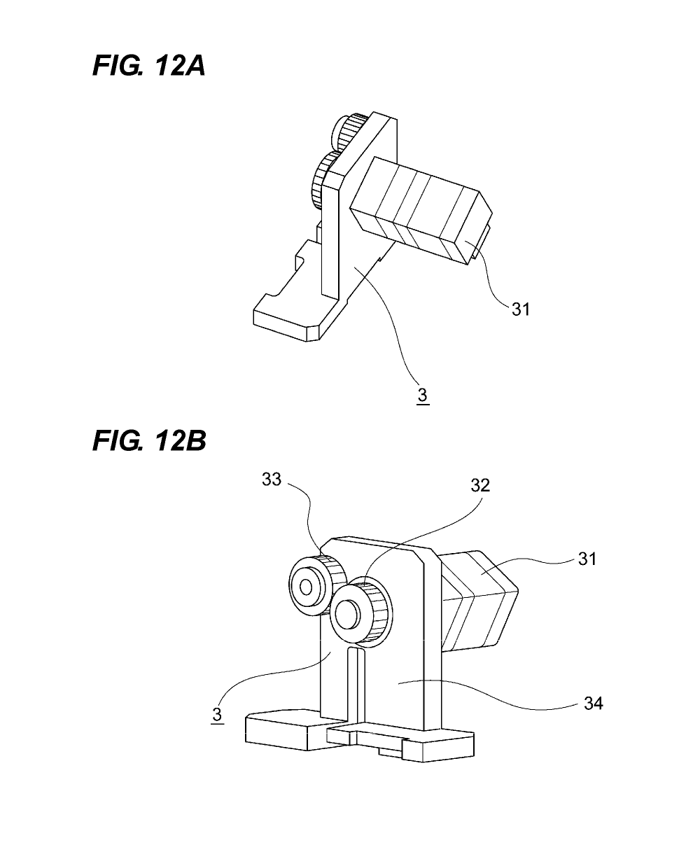

FIG. 12A is a diagram in which the motor unit 3 is viewed from the right front up direction, and FIG. 12B is a diagram in which the motor unit 3 is viewed from the left front up direction. A driving force is applied from the motor unit 3 to the movable feeding guide unit 1.

The driving force is transmitted in a manner such that a motor gear 32 rotating along with a motor shaft engages with an idle gear 33 rotating along with the inner conveying roller shaft 1411. The motor unit 3 is fixed to the base frame 20.

Hereinafter, members such as a cam gear will be described. In many cases, the members are provided so as to be symmetrical to each other at the left and right sides of the sheet stacking portion. Here, the members that are disposed so as to be bilaterally symmetrical to each other substantially have the same configuration. Therefore, in the description below, the left member will be described, and the right member corresponding thereto will be put in parentheses.

### (Cam Gear)

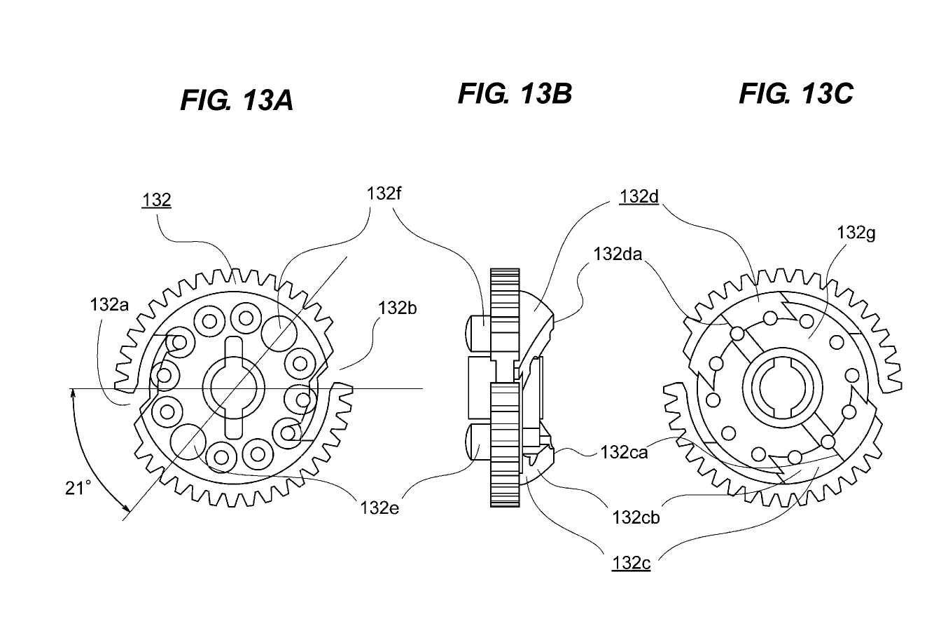

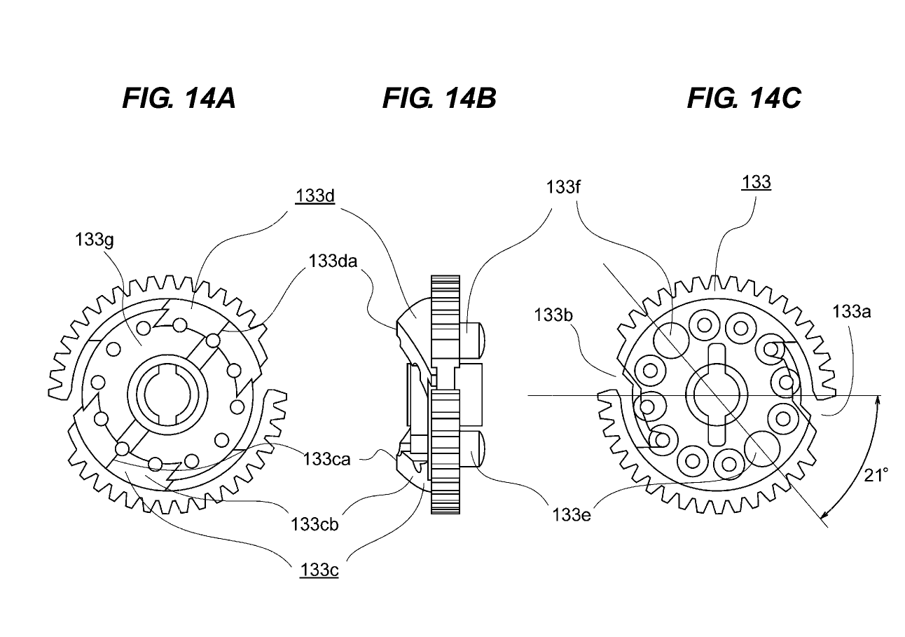

Next, the cam gear 132 (133) will be described. FIGS. 13A to 13C illustrate the left cam gear 132, where FIG. 13A is a diagram in which the left cam gear is viewed from the left direction, FIG. 13B is a diagram in which the left cam gear is viewed from the front direction, and FIG. 13C is a diagram in which the left cam gear is viewed from the right direction. Further, FIGS. 14A to 14C illustrate the right cam gear 133, where FIG. 14A is a diagram in which the right cam gear is viewed from the left direction, FIG. 14B is a diagram in which the right cam gear is viewed from the front direction, and FIG. 14C is a diagram in which the right cam gear is viewed from the right direction.

The cam gear 132 (133) transmits the driving force generated by the main motor 31 in order of the main motor 31, the motor gear 32, the idle gear 33, the inner conveying roller gear 1415 (1416), the cam gear 132 (133), a feeding gear 115 (116), the feeding shaft 111, and the feeding rubber roller 112. Alternatively, the transmission of the driving force to the member from the feeding gear 115 (116) is interrupted in a manner such that the inner conveying roller gear 1415 (1416) and the cam gear 132 (133) are separated from each other whenever the cam gear rotates by a half revolution.

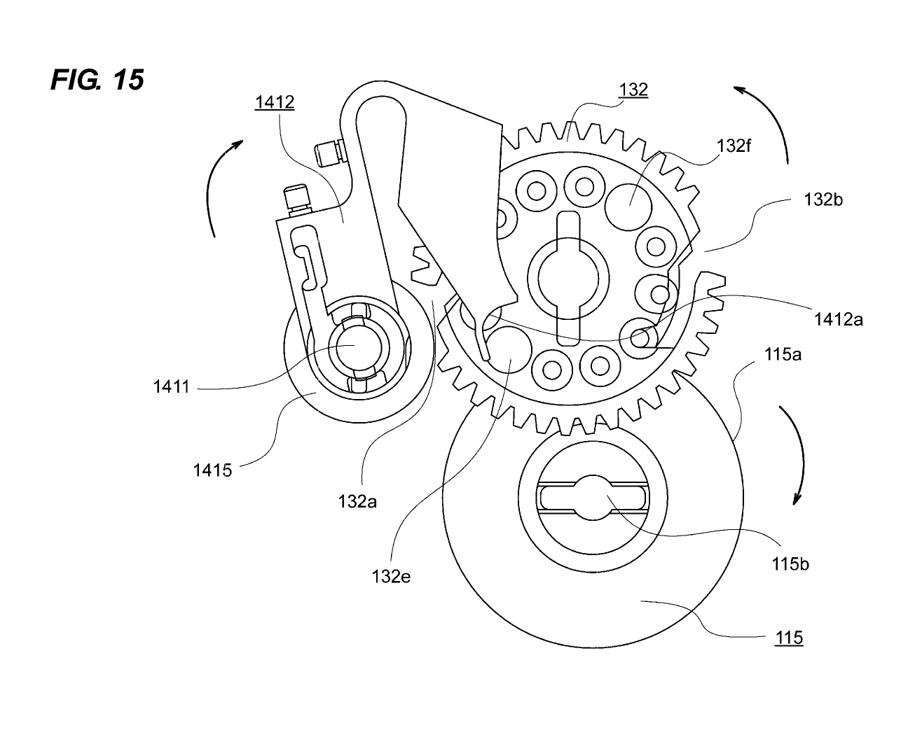

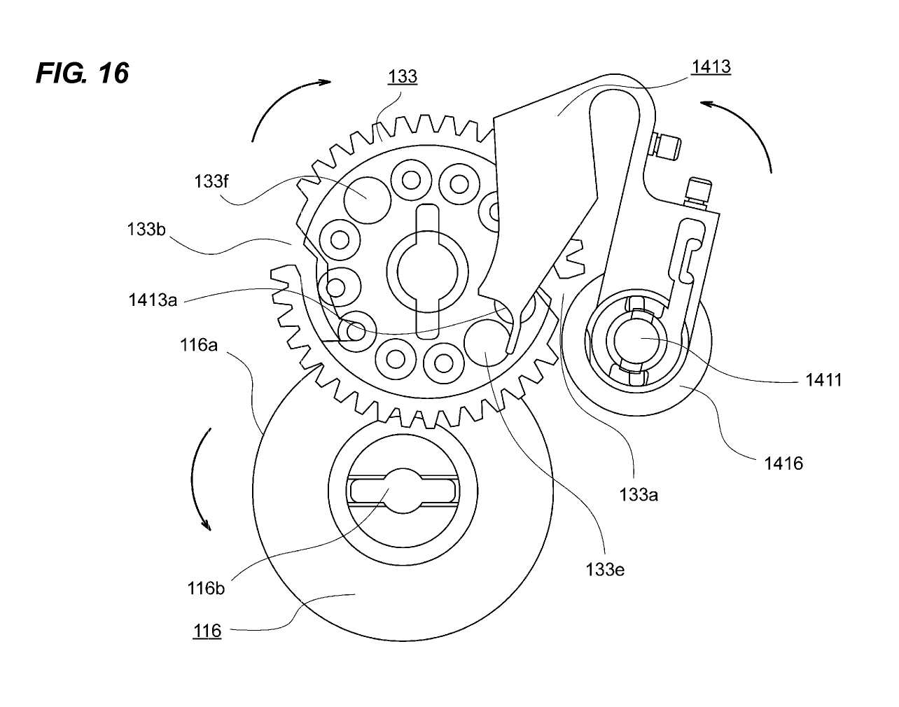

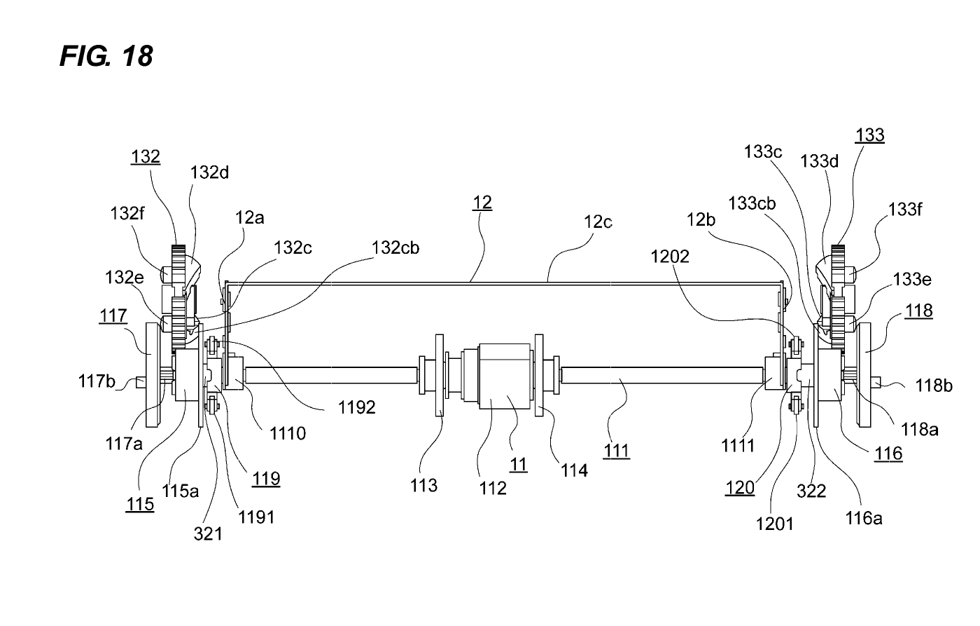

By the rotation position of the cam gear 132 (133), the position of the feeding gear 115 (116) (see FIGS. 15 and 16) in the thrust direction is changed. Accordingly, when the ON/OFF timing of the clutch formed by the feeding gear 115 (116) and a link disk 117 (118) (see FIG. 18) is controlled, the movement (including the movement direction) and the stop timing of the movable guide 17 are controlled.

The cam gear 132 (133) is coupled to the cam gear shaft 131 (see FIG. 3) rotatably journaled to the frame 12 by a parallel pin or the like. The pitch circle diameter of the cam gear is set to be substantially twice the pitch circle diameter of the feeding gear so that the feeding gear 115 (116) may rotate by one revolution through the half revolution of the cam gear 132 (133).

Then, the cam gear 132 (133) is provided with missing teeth portions 132a and 132b (133a and 133b) which do not have gear teeth every half revolution so that the driving force transmitted from the main motor 31 may be interrupted every rotation of the feeding gear 115 (116).

As illustrated in FIGS. 13A to 14C, the side surface of the cam gear 132 (133) facing the frame is provided with two mountain-shaped protrusions 132c and 132d (133c and 133d) which are provided at the interval of 180° on a circle and are formed such that a circular-arc being concentric with the rotation center of the cam gear protrudes toward the frame while having the center line in the width direction. Then, the mountain shape is formed such that the tapered angle of the slope of the mountain having a symmetrical shape with respect to top ridge portions 132ca and 132da (133ca and 133da) in the circumferential direction is uniformly 30°.

Both top ridge portions 132ca and 132da (133ca and 133da) of the mountain-shaped protrusions 132c and 132d (133c and 133d) exist on the line passing through the rotation center. Then, the midpoints of the top ridge portions exist at the same position from the rotation center.

Cylindrical cam bits 132e and 132f (133e and 133f) are uprightly formed at the positions which are located at the side surface opposite to the side surface provided with the mountain-shaped protrusions of the cam gear and face the midpoint of the top ridge portions 132ca and 132da (133ca and 133da). The cam bit causes the cam gear 132 (133) to start to rotate by receiving a trigger action from a catch portion 1412a (1413a) of the trigger lever 1412 (1413).

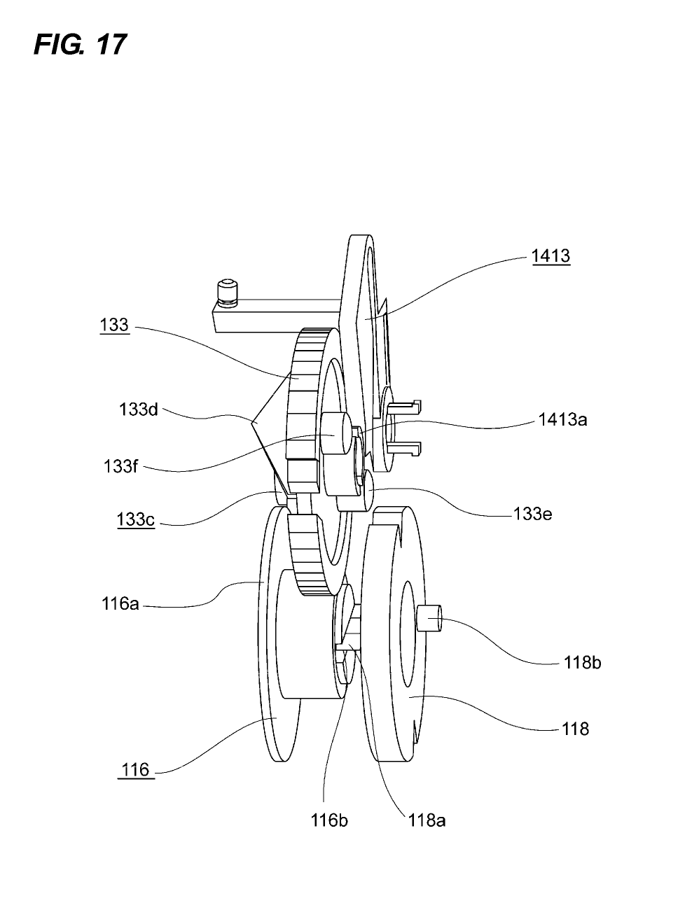

FIG. 15 is a diagram illustrating a positional relation among the left trigger lever 1412, the cam gear 132, and the feeding gear 115, and FIG. 16 is a diagram illustrating a positional relation among the right trigger lever 1413, the cam gear 133, and the feeding gear 116. Further, FIG. 17 is a diagram illustrating a positional relation between the right feeding gear 116 and the link disk 118, and FIG. 18 is a diagram in which the feeding roller 11 is viewed from the front direction.

The standby position of the cam gear 132 (133) is located at a position in which the missing teeth portion 132a (133a) faces the inner conveying roller gear 1415 (1416). At the position, even when the main motor 31 is driven so that the inner conveying roller gear 1415 (1416) rotates, the gear teeth of the inner conveying roller gear and the cam gear 132 (133) do not engage with each other. Thus, the driving force is not transmitted therebetween.

At the standby position of the cam gear 132 (133), the line that connects the top ridge portions 132ca and 132ca (133ca and 133da) of two mountain-shaped protrusions is inclined by 21° with respect to the horizontal line passing through the rotation center in the clockwise direction when viewed from the right direction. At this time, the feeding gear 115 (116) which is positioned in the thrust direction while a flange edge 115a (116a) contacts a mountain-shaped tapered surface 132cb (133cb) of the cam gear is in a state where an elongated groove portion 115b (116b) slightly enters a convex portion 117a (118a) (see FIGS. 17 and 18) of the link disk 117 (118).

### (Feeding Gear)

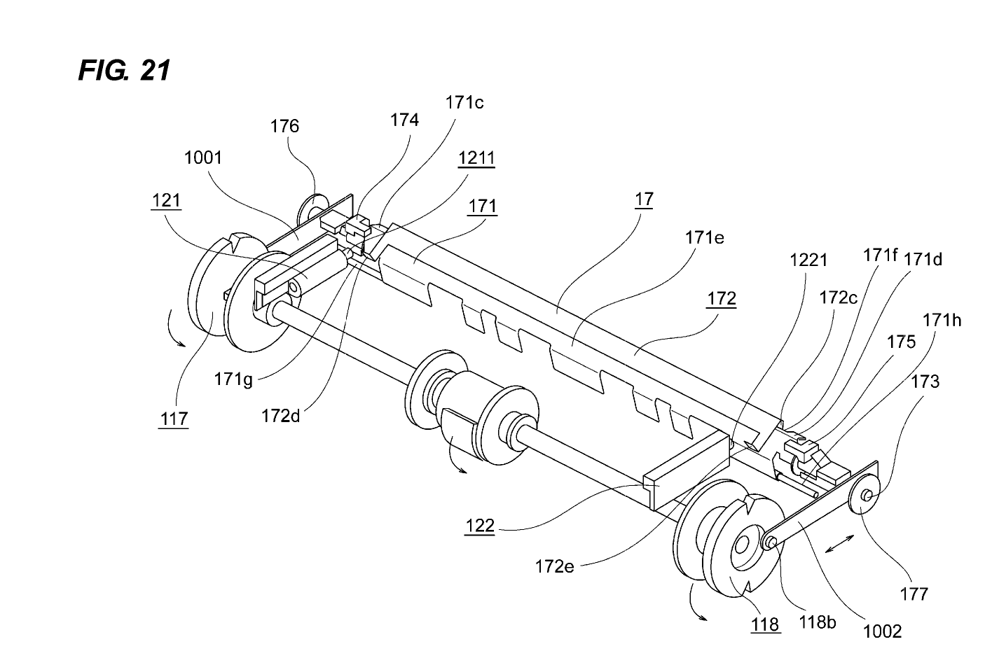

The feeding gear 115 (116) transmits the driving force transmitted from the cam gear 132 (133) in order of the cam gear 132 (133), the feeding gear 115 (116), the feeding shaft 111, and the feeding rubber roller 112. Here, the rotation force of the feeding gear 115 (116) is transmitted to the circular link disk 117 (118) being coaxial to the feeding shaft 111 or the transmission is interrupted. As a result, the movable guide 17 is moved or stopped by a crank mechanism including the link disk 117 (118) and a link 1001 (1002) (see FIG. 21) in order to drive or do not drive the movable guide 17 by the crank mechanism. For this reason, the configuration is set as below.

The feeding gear 115 (116) normally engages with the cam gear 132 (133). The feeding gear 115 (116) is integrally coupled to a spring pin (not illustrated) which is uprightly formed in a direction perpendicular to the feeding shaft 111 rotatably supported by the frame 12. The feeding gear 115 (116) is provided in a state where the elongated groove portion 115b (116b) fitted to the spring pin so that the spring pin (not illustrated) is movable through a guide in the thrust direction of the feeding shaft 111 penetrates the side surfaces of the feeding gear 115 (116) in the thrust direction.

As illustrated in FIG. 18, the feeding gear 115 (116) is biased by a compression spring 321 (322) provided between the feeding gear and a release cam 119 (120) so that the feeding gear is separated from the frame 12a (12b) in the direction of the feeding shaft 111. Accordingly, the flange edge 115a (116a) of the feeding gear 115 (116) is pressed against the tapered surface 132cb (133cb) of the mountain-shaped protrusion of the cam gear 132 (133), and hence the position of the feeding gear 115 (116) is determined in the thrust direction. In other words, the position of the feeding gear 115 (116) in the thrust direction may be determined by the rotation positions of the mountain-shaped protrusions 132c and 132d (133c and 133d) of the cam gear 132 (133).

The standby position of the feeding gear 115 (116) corresponds to a state where the elongated groove portion 115b (116b) slightly enters the convex portion 117a (118a) of the link disk 117 (118).

### (Trigger)

FIG. 19 is a diagram in which a triggering component is viewed from the right back up direction. Here, the trigger rod 152 (162) may start to move linearly forward by a biasing spring (not illustrated).

The trigger rod 152 (162) is stopped at the standby position. Alternatively, the rotation force is transmitted along the route of the trigger rod 152 (162), the trigger lever 1412 (1413), the cam bit 132e (133e), and the cam gear 132 (133) by the linear movement of the trigger rod 152 (162) in the forward direction. Accordingly, the cam gear 132 (133) engages with the inner conveying roller gear 1415 (1416), and continuously rotate by the driving force of the main motor 31. While the cam gear 132 (133) rotates by a half revolution from the standby position, the trigger rod 152 (162) is returned to the standby position.

For this reason, the configuration is set as below. A trigger 182 (183) is integrally fixed to both sides of the trigger shaft 181 by a snap ring (not illustrated). The trigger shaft 181 is rotatably supported by the frame 12 so as to be slidable in the thrust direction. The trigger shaft 181 is integrally fixed to a solenoid body 1851 by a body-shaft coupling portion 184. The trigger shaft 181 is biased leftward by a solenoid compression spring (not illustrated) provided between the frame 12 and a circular link (not illustrated) concentrically fixed to the trigger shaft 181 so that the solenoid body 1851 returns to the standby position when a solenoid 185 is not operated.

The standby position of the trigger 182 (183) corresponds to a state where the trigger is pressed leftward by a solenoid compression spring (not illustrated) so that the trigger rod 152 (162) accumulates a spring force of a trigger rod compression spring (not illustrated) as much as possible. At this time, the trigger 182 (183) enters a recessed portion 152a (162a) of the trigger rod 152 (162), and an abutting surface 182a (183a) of the trigger 182 (183) contacts a recessed abutting surface 152b (162b) of the trigger rod 152 (162) so that the forward movement of the trigger rod 152 (162) is regulated.

The trigger 182 (183) is provided with a triangular surface 182b (183b) so that the trigger is pressed rightward while the triangular surface rubs off a triangular surface 152c (162c) of the trigger rod 152 (162) when the trigger rod 152 (162) returns to the standby position (the rear position).

### (Trigger Rod)

The trigger rod 152 (162) has a function of triggering the cam gear 132 (133) located at the standby position where the missing teeth portion 132a (133a) faces the inner conveying roller gear 1415 (1416) so that the cam bear rotates and engages with the inner conveying roller gear 1415 (1416).

The route for the engagement state is set in order of the solenoid 185, the body-shaft coupling portion 184, the trigger shaft 181, the trigger 182 (183), the trigger rod 152 (162), a trigger lever connection portion 1414, the trigger lever 1412 (1413), the cam bit 132e (133e), the cam gear 132 (133), and the inner conveying roller gear 1415 (1416).

Furthermore, the movement direction (the front to back direction) of the trigger rod 152 (162) forms a right angle with respect to the movement direction (the left and right direction) of the trigger 182 (183). The trigger rod 152 (162) returns to the initial position every half revolution of the cam gear 132 (133).

For this reason, the configuration is set as below. The trigger rod 152 (162) is movable in a reciprocating manner in the front to back direction by using a groove portion (not illustrated) of the mold frame 15 (16) as a guide, and is biased forward by a compression spring (not illustrated) between the trigger rod 152 (162) and the mold frame 15 (16). The forward movement of the trigger rod 152 (162) is regulated by a stopper 153 (163) (see FIG. 3) of the mold frame 15 (16).

The standby position of the trigger rod 152 (162) corresponds to a state where a compression spring (not illustrated) is shortened as much as possible so that a spring force is accumulated as much as possible. The position is formed in a manner such that the abutting surface 182a (183a) of the trigger 182 (183) contacts the recessed abutting surface 152b (162b) of the trigger rod 152 (162) so as to regulate the forward movement of the trigger rod 152 (162).

The trigger rod 152 (162) is provided with the triangular surface 152c (162c) so that the trigger 182 (183) is pressed rightward while the triangular surface rubs off the triangular surface 182b (183b) of the trigger 182 (183) when the trigger rod returns to the standby position.

### (Release Cam)

FIG. 20 is a diagram in which the right release cam 120 presses the sheet supporting plate 214 as much as possible. At this time, the left release cam 119 presses the sheet supporting plate 214 in this way even at the left side (see FIG. 32). When the cam gear 132 (133) rotates forward (backward) by a half revolution, the sheet supporting plate 214 is moved upward by a pressing force of a compression spring (a pressing portion) between the sheet supporting plate 214 and a bottom 21c of the cassette box 21 at the feeding timing, so that the feeding rubber roller 112 contacts the uppermost sheet 210 inside the cassette box 21. As a result, since a pressing force is generated therebetween, the uppermost sheet 210 may be fed.

When the movable guide 17 integrated with the sheet tip end holding portion 172 moved toward the feeding roller 11 while the sheet tip end is held by the sheet tip end holding portion 172, it is desirable to decrease the load resistance at the sheet tail end as low as possible. Therefore, in the embodiment, the sheet supporting plate 214 is moved down, so that the pressing force is not generated between the uppermost sheet 210 and the feeding rubber roller 112.

The release cam 119 (120) serves as a pressing release portion that releases a state where the pressing portion presses the sheet against the feeding rubber roller 112 when the sheet tip end holding portion 172 and the movable guide 17 moves from the first position to the second position.

For that reason, the release cam 119 (120) is integrally coupled to the feeding shaft 111 by a parallel pin (not illustrated), and hence rotates along with the feeding shaft. One roller 1191 (1201) of two rollers 1191 and 1192 (1201 and 1202) rotatably provided in the release cam 119 (120) is disposed so that the outer peripheral surface thereof contacts both ends 214c (214d) (see FIG. 10) of the sheet supporting plate 214. As illustrated in FIGS. 10 and 11, the sheet supporting plate 214 has a configuration in which a boss portion 214a (214b) is rotatably supported by the hole 21a (21b) of the cassette box 21 and is biased upward by a compression spring (not illustrated).

The rotation position of the sheet supporting plate 214 is determined by the rotation position of the release cam 119 (120). The semi-circular size of the release cam 119 (120), the sizes of the rollers 1191 and 1192 (1201 and 1202), and the abutting position with respect to the sheet supporting plate 214 are determined so that a pressing force is generated in a manner such that the uppermost sheet 210 inside the cassette box 21 is pressed from the sheet supporting plate 214 by the feeding rubber roller 112 regardless of the sheet stacking amount (a small stacking amount to a full stacking amount) inside the cassette box 21 in the range of the rotation angle 32.5 to 112.5° of the feeding rubber roller 112.

The timing of releasing the pressing force of the sheet supporting plate 214 matches the timing in which the missing teeth portions 132a and 132b (133a and 133b) of the cam gear 132 (133) pass through the feeding gear 115 (116). At this time, the feeding shaft 111 receives a force in a direction opposite to the feeding rotation direction from the pressing force of the sheet supporting plate 214. As a result, a deviation occurs in the engagement of the teeth between the cam gear 132 (133) and the feeding gear 115 (116). In order to prevent this problem, as illustrated in FIG. 18, a one-way clutch 1110 (1111) is provided inside the feeding shaft 111 so as to prevent the reverse rotation.

Further, in the missing teeth portions 132a and 132b (133a and 133b) of the cam gear 132 (133), there is a need to prevent a deviation in the engagement of the teeth between the cam gear and the feeding gear when the feeding gear 115 (116) rotates too much by the inertia. For that reason, in the embodiment, a slight load brake (not illustrated) is applied to the feeding shaft 111. The standby position of the release cam 119 (120) corresponds to a position where the sheet supporting plate 214 is pressed downward as much as possible.

### (Feeding Roller)

At the first rotation of the feeding rubber roller 112, the feeding roller feeds the uppermost sheet 210 of the cassette box 21, and feeds one sheet separated by the slope separation portion 25 until the sheet reliably abuts against the sheet tip end holding portion 172. At the second rotation of the feeding rubber roller 112, the feeding roller feeds the sheet waiting at the second position to the pair of conveying rollers 14 in synchronization with the image forming timing.

The feeding amount obtained by the semi-circular shape of the feeding rubber roller 112 is not involved with a decrease in feeding amount caused by a degradation in durability and a change in feeding amount caused by the position of the sheet inside the cassette box 21 (in accordance with the small stacking amount to the full stacking amount), and the sheet tip end reliably abuts against the sheet tip end holding portion 172. For that reason, the feeding amount obtained by the semi-circular shape of the feeding rubber roller 112 is set with an allowance compared to the distance between the feeding point position and the position where the sheet tip end abuts against the sheet tip end holding portion. The extra amount of the sheet which is fed by the feeding rubber roller 112 is generally formed as a loop (a slack portion). However, in the case of the embodiment, the loop is released to the sheet tail end side since the state where the sheet is pressed by the sheet supporting plate 214 is immediately released by the release cam 119 (120) after the feeding operation is completed.

As illustrated in FIG. 18, both ends of the feeding rubber roller 112 are provided with an auxiliary roller 113 (114) rotating concentrically. The radius of the auxiliary roller 113 (114) is slightly smaller than that of the feeding rubber roller 112. Further, when the sheet supporting plate 214 is moved down as much as possible by the release cam 119 (120), a minute gap is formed between the auxiliary roller 113 (114) and the uppermost sheet 210 in the state where the cassette box 21 is full of the sheets.

The standby position of the feeding rubber roller 112 is set so that the feeding start point and the feeding end point become the positions of 32.5° and 112.5° in the clockwise rotation direction of the feeding shaft when viewed from the right direction.

### (Movable Guide)

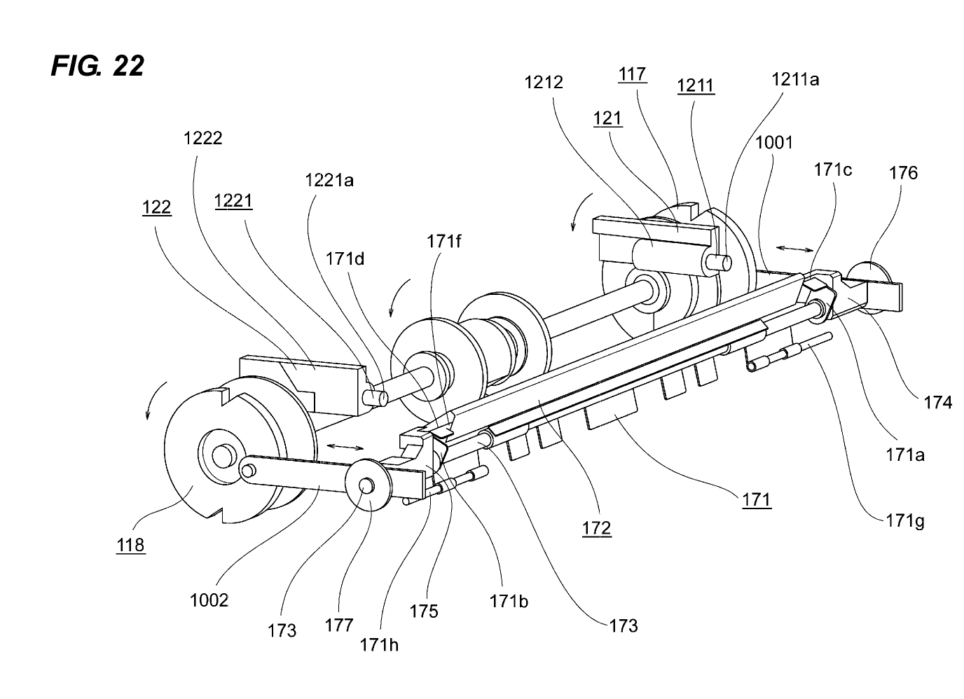

FIG. 21 is a diagram in which the periphery of the movable guide 17 is viewed from the right front up direction, and FIG. 22 is a diagram in which the periphery of the movable guide 17 is viewed from the right back direction.

A movable guide plate 171 guides one sheet fed by the feeding rubber roller 112 and separated by the slope separation portion 25 to the sheet tip end holding portion 172 located at the first position on the downstream side in the sheet feeding direction in relation to the slope separation portion 25. The movable guide plate 171 moves to the second position where the movable guide plate returns to the feeding roller 11 along with the sheet tip end holding portion 172 while the sheet tip end is held by the sheet tip end holding portion 172.

The movable guide plate 171 moves from the first position to the second position so as to supply the sheet to the pair of conveying rollers 14, and returns from the second position to the first position along with the sheet tip end holding portion 172 so as to wait for the supply of the next sheet (so as to hold the sheet tip end).

The postures of the movable guide plate 171 and the sheet tip end holding portion 172 change while moving between the first position and the second position. That is, when the movable guide plate 171 and the sheet tip end holding portion 172 move from the first position to the second position, the postures are first inclined from the substantially upright state at the standby position so that the movable guide plate 171 and the sheet tip end holding portion 172 dive to the lower side of the pair of conveying rollers 14. Further, when the sheet tip end holding portion 172 is rotated by the switch portion 121 (122) so as to cancel the holding function and the sheet is fed to the pair of conveying rollers 14 by the feeding rubber roller 112, the postures thereof change to the upright postures again so that the sheet tip end smoothly enters the pair of conveying rollers 14. The postures changes in the opposite posture when the movable guide plate 171 and the sheet tip end holding portion 172 return from the second position to the first position.

The sheet which passes through the slope separation portion 25 is smoothly delivered without being caught by the movable guide plate 171. This is because the movable guide plate 171 is disposed so as to engage with the slope separation portion 25 in a comb teeth shape. Thus, no joint exist in the sheet traveling direction. Further, this is because the surface position of the movable guide plate 171 is set to a position deeper than the slope separation portion 25.

In order to change the postures of the movable guide plate 171 and the sheet tip end holding portion 172 from the first position to the second position, the configuration is set as below.

As illustrated in FIG. 22, the movable guide plate 171 has a configuration in which both ends thereof are rotatably supported by a guide shaft 173 through a bent portion 171a (171b). A mold holder 174 (175) is fitted and fixed to each of both ends of the guide shaft 173, and the movable guide plate 171 is biased in the counter-clockwise direction when viewed from the right direction by a torsion spring (not illustrated) provided between the mold holder 174 (175) and the bent portion 171a (171b) of the movable guide plate 171.

As illustrated in FIGS. 6 to 7C, a change in posture of the movable guide plate 171 and the sheet tip end holding portion 172 moves the roller 176 (177) rotatably supported by the end of the guide shaft 173 while the roller slides on the sliding surface 15a (16a) of the mold frame 15 (16). Also, a corner 171c (171d) of the movable guide plate 171 is moved along an outer line 151a (161a) of the posture changing guide 151 (161).

When the postures of the movable guide plate 171 and the sheet tip end holding portion 172 are inclined, the outer line 151a (161a) is set so that the movable guide plate 171 is opened in the clockwise direction when viewed from the right direction against a torsion spring (not illustrated). Since the corner 171c (171d) of the movable guide plate 171 is pressed against the outer line 151a (161a) of the posture changing guide 151 (161) by the biasing force, the inclined postures of the movable guide plate 171 and the sheet tip end holding portion 172 may be maintained.

In order to change the inclination angle, the rotation angle of the movable guide plate 171 is changed. In order to return the postures of the movable guide plate 171 and the sheet tip end holding portion 172 to the standby position, the outer line 151a (161a) is set so that the movable guide plate 171 and the sheet tip end holding portion 172 do not rotate in the clockwise direction.

The movable guide 17 is coupled to the rear side end of the link 1001 (1002) with an allowance in a direction perpendicular to the guide shaft 173 at both ends of the guide shaft 173. The front side end of the link 1001 (1002) is rotatably supported by a convex cylindrical portion 117b (118b) of the rotating link disk 117 (118).

The movable guide 17 is movable in the front to back direction in a reciprocating manner by the crank mechanism which is formed by the link 1001 (1002) moving along with the rotation of the link disk 117 (118). The position of the movable guide in the front to back direction is determined by the rotation position of the link disk.

The sheet tip end holding portion 172 is supported so as to be rotatable with respect to the guide shaft 173. Accordingly, the movable guide plate 171 is movable along with the sheet tip end holding portion 172.

### (Sheet Tip End Holding Portion)

FIG. 23 is a diagram (a cross-sectional view) in which the periphery of the sheet tip end holding portion 172 and an inner guide 123 are viewed from the right direction. The tip end of the sheet separated by the slope separation portion 25 is held. Then, the sheet holding function of holding the sheet by the sheet tip end holding portion 172 is enabled or disabled by the switch portion 121 (122).

The sheet tip end holding portion 172 includes a guide portion 172a which is inclined by 45° with respect to a surface 171e of the movable guide plate 171 so that the sheet entering along the movable guide plate 171 reliably enters an abutting portion 172b. The sheet tip end holding portion 172 is supported so as to be rotatable with respect to the guide shaft 173 rotatably supported by the movable guide plate 171. A torsion spring (not illustrated) is provided between the sheet tip end holding portion and the movable guide plate 171, and hence the sheet tip end holding portion is biased in the counter-clockwise direction when viewed from the right direction.

The standby position of the sheet tip end holding portion 172 corresponds to a position where a flat surface portion 172c is biased toward a recessed edge 171f of the movable guide plate 171. Further, a projection portion 172d (172e) which is opened or closed by the switch portion 121 (122) is provided.

### (Switch Portion)

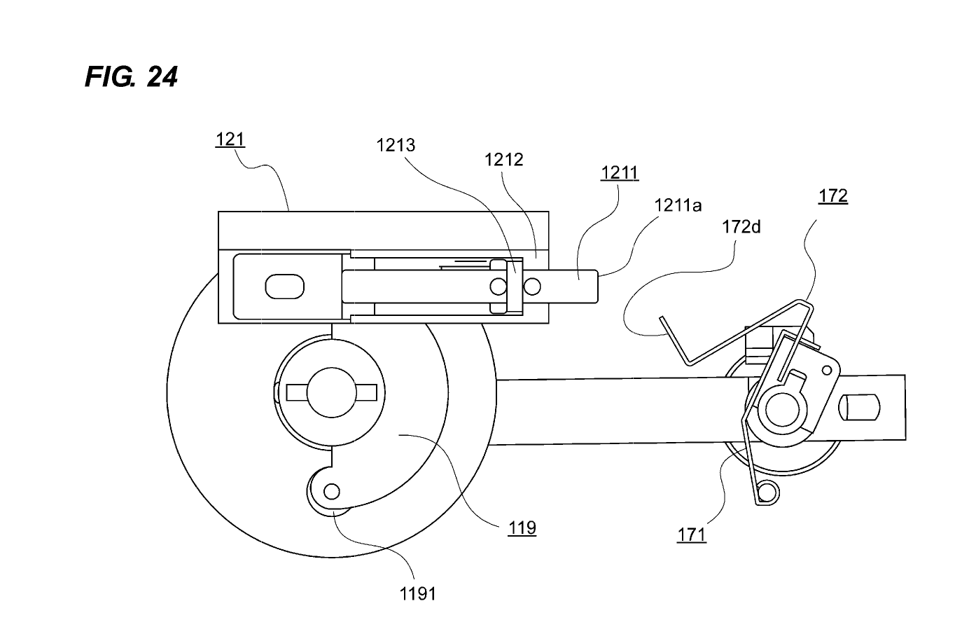

FIG. 24 is a diagram (a cross-sectional view) in which the left switch portion 121 is viewed from the right direction. The switch portion 121 (122) enables or disables the sheet holding function of the sheet tip end holding portion 172. The switch portion 121 (122) serves as a holding release portion that releases the sheet held by the sheet tip end holding portion which holds the sheet tip end when the sheet tip end holding portion 172 moves from the first position to the second position.

For that reason, as illustrated in FIGS. 22 and 24, the switch portion 121 (122) includes a pressing cylinder 1211 (1221). Further, the switch portion 121 (122) includes a guide portion 1212 (1222) which moves the pressing cylinder in the front to back direction and a stopper 1213 (where the stopper of the right pressing cylinder is not illustrated) which determines the position of the pressing cylinder in the backward direction. Further, the switch portion 121 (122) includes a compression spring (not illustrated) that applies a biasing force to the pressing cylinder backward. Then, these members are fixed to the frame 12 in the form of units.

When the movable guide plate 171 moves from the first position to the second position along with the sheet tip end holding portion 172, the projection portion 172d (172e) of the sheet tip end holding portion 172 abuts against a front end 1211a (1221a) of the pressing cylinder 1211 (1221) in the vicinity of the second position. The biasing force of the sheet tip end holding portion 172 is set to be weaker than the biasing force of the pressing cylinder 1211 (1221). For this reason, when the movable guide plate 171 further moves forward, the sheet tip end holding portion 172 is opened in the clockwise direction when viewed from the right direction against the biasing force of the sheet tip end holding portion 172.

The position of the front end 1211a (1221a) of the pressing cylinder 1211 (1221) in the front to back direction, the compression spring pressure (at the timing of opening the sheet tip end holding portion 172), and the surface properties of a triangular pillar portion 123a of the inner guide 123 and the guide portion 172a of the sheet tip end holding portion 172 are adjusted. Accordingly, the sheet tip end holding portion 172 is opened, and the sheet tip end may be set to a stable position in the vicinity of the sheet tip end holding portion 172. This state corresponds to a state where a shutter for determining the position of the sheet tip end originally exists at the second position.

### (Inner Guide)

The inner guide 123 forms a sheet conveying path while facing the movable guide plate 171 so that the sheet fed by the feeding rubber roller 112 at the second position smoothly enters the pair of conveying rollers 14.

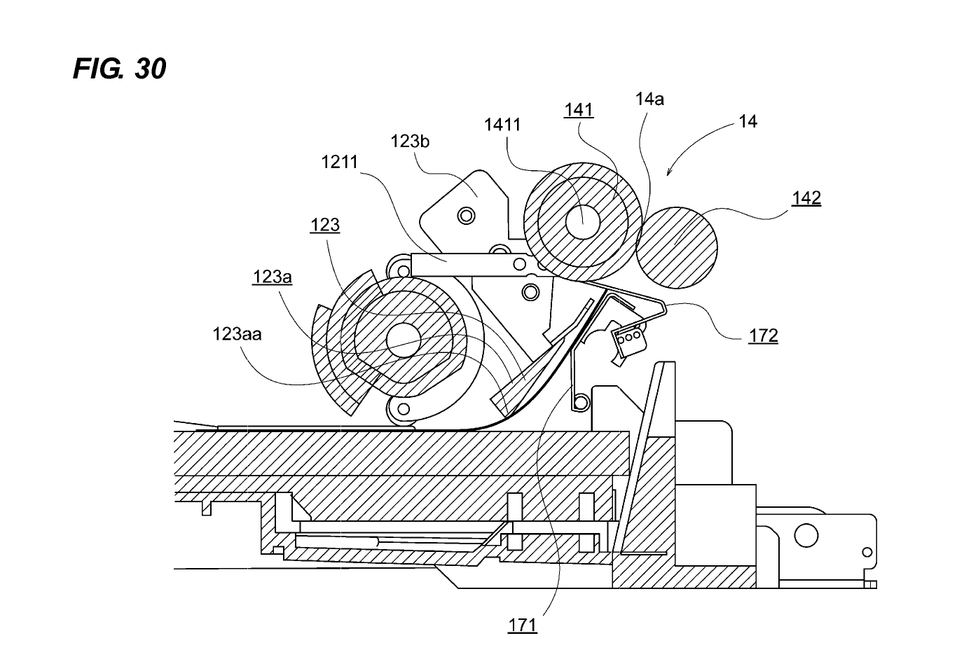

The inner guide 123 is used to smoothly discharge the sheet tip end when the sheet tip end holding portion 172 is opened at the second position or the sheet tip end holding portion 172 is opened in the vicinity thereof. For that reason, the posture of the sheet is erected in the counter-clockwise direction when viewed from the right direction by the contact with respect to a ridge portion 123aa of the triangular pillar portion 123a of the inner guide 123 at the downstream position from the feeding point (see FIG. 30).

As illustrated in FIG. 23, the inner guide 123 includes the triangular pillar portion 123a having a triangular cross-section and a sheet metal portion 123b supporting the triangular pillar portion 123a, and the triangular pillar portion 123a is fixed by a double-sided tape (not illustrated) while maintaining a relative positional relation with respect to the sheet metal portion 123b. The sheet metal portion 123b is fixed to the left frame portion 12a and the right frame portion 12b while maintaining the relative positional relation.

### (Movable Guide Posture Changing Unit)

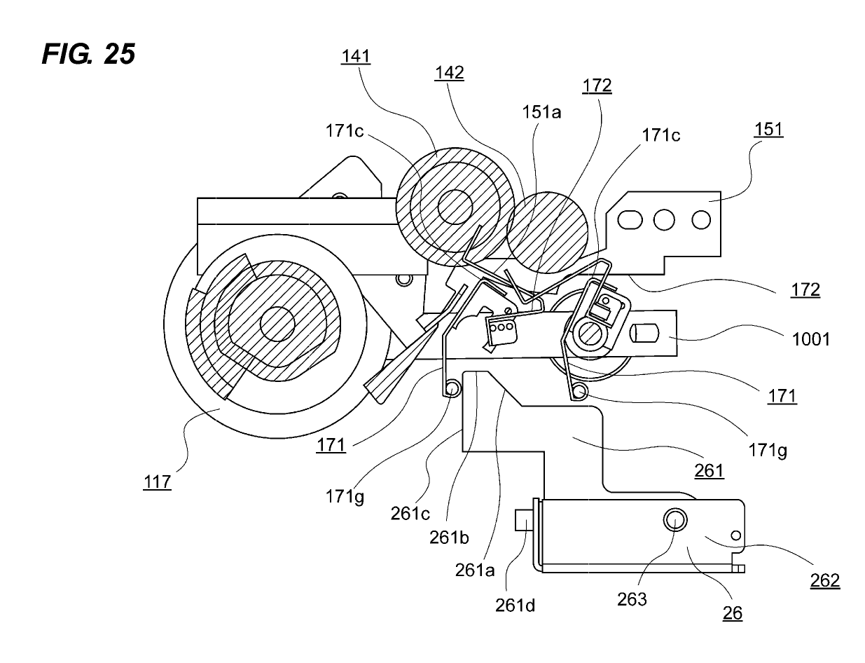

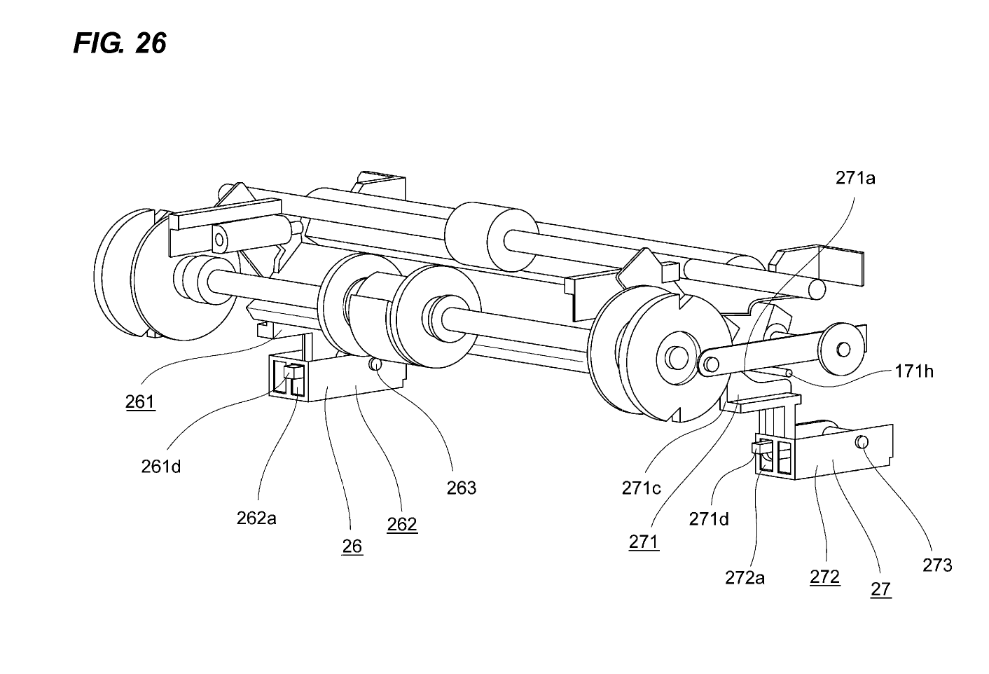

FIG. 25 is a diagram in which the left movable guide posture changing unit 26 is viewed from the right direction, and FIG. 26 is a perspective view in which the movable guide posture changing unit is viewed from the right direction.

When the movable guide plate 171 is returned from the second position to the first position, the movable guide plate 171 is inclined in the clockwise direction at the second position when viewed from the right direction. For that reason, the corner 171c (171d) of the movable guide plate 171 and the outer line 151a (161a) of the posture changing guide 151 (161) (see FIGS. 6 to 7C) are locked even when the movable guide plate is returned in the same route, and hence the operation may not be started.

In order to solve this problem, a mechanism is provided which changes the posture of the movable guide plate 171 so that the movable guide plate is inclined so as to be substantially parallel to the outer line 151a (161a) of the posture changing guide 151 (161) when the operation starts and hence does not lock the corner 171c (171d) of the movable guide plate 171 and the outer line 151a (161a) of the posture changing guide 151 (161). However, damage does not occur when the movable guide plate moves from the first position to the second position.

For that reason, an L-shaped arm 261 (271) is rotatably provided in a U-shaped member 262 (272) through a shaft 263 (273), and is supported while a projection portion 261d (271d) enters a square hole 262a (272a) of the U-shaped member 262 (272). Then, the L-shaped arm is biased in the clockwise direction by a torsion spring (not illustrated) when viewed from the right direction. The L-shaped arm 261 (271) includes a slope 261a (271a) which is inclined by 30° from the horizontal plane in the clockwise direction, a horizontal plane 261b (271b), and a vertical plane 261c (271c) when viewed from the right direction. A bar-shaped portion 171g (171h) protrudes toward both sides of the movable guide plate 171.

The standby position of the L-shaped arm 261 (271) corresponds to a position where the projection portion 261d (271d) contacts the edge of the square hole 262a (272a) by a biasing force generated by a torsion spring (not illustrated). The L-shaped arm 261 (271) starts to rotate in the counter-clockwise direction against the biasing spring if the bar-shaped portion 171g (171h) reaches the slope 261a (271a) when the movable guide plate 171 moves from the first position to the second position. Subsequently, the L-shaped arm is pressed down as much as possible at the position passing through the horizontal plane 261b (271b), and returns to the original position by a biasing force generated by a torsion spring (not illustrated) at the position passing by the horizontal plane 261b (271b).

When the movable guide plate 171 starts to return from the second position to the first position, the bar-shaped portion 171g (171h) of the movable guide plate 171 contacts the vertical plane 261c (271c) of the L-shaped arm 261 (271). At this time, a rotation moment is generated in the L-shaped arm 261 (271) in the clockwise direction when viewed from the right direction. However, since each of the edges of the square holes 262a (272a) becomes a stopper, the edge remains stopped.

Meanwhile, a backward force is exerted in the guide shaft 173 of the movable guide 17 through the link 1001 (1002) along with the rotation of the link disk 117 (118). Thus, since a rotation moment is generated in the movable guide plate 171 in the clockwise direction about the bar-shaped portion 171g (171h) when viewed from the right direction, the movable guide plate rotates in the same direction.

When the movable guide plate 171 rotates so as to be substantially parallel to the outer line 151a of the posture changing guide 151, the locking state between the corner 171c and the outer line 151a is released, and hence the movable guide plate 171 starts to move backward. Simultaneously, the bar-shaped portion 171g (171h) moves upward along the vertical plane 261c (271c) of the L-shaped arm 261 (271) and passes by the horizontal plane 261b (271b) and the slope 261a (271a). By this series of movement, the movable guide plate 171 returns to the standby position, and the L-shaped arm 261 (271) also returns to the standby position.

Next, the operation of each member during the continuous operation of the sheet feeding device of the embodiment will be described according to each step (S1 to S3).

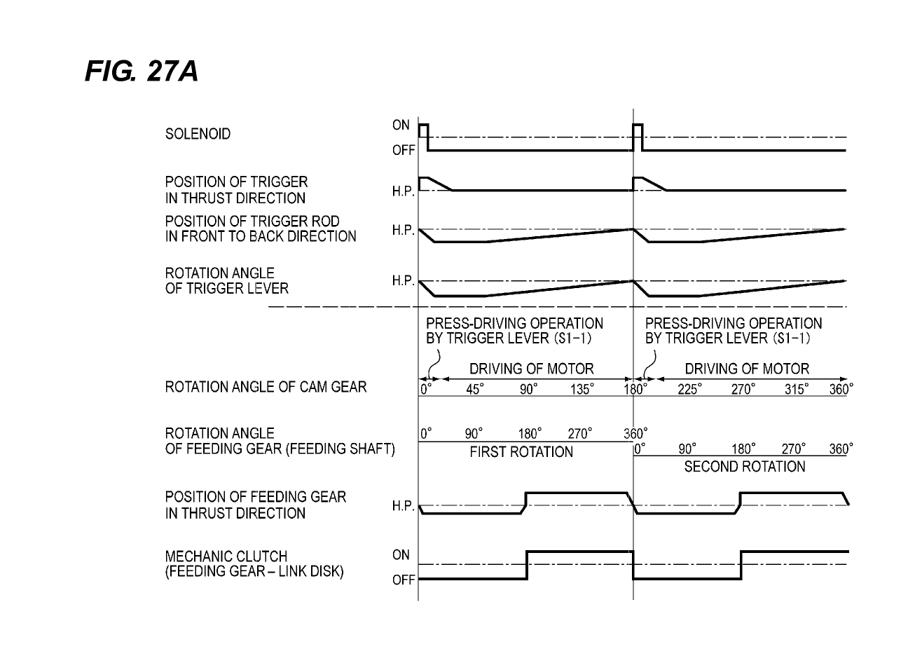

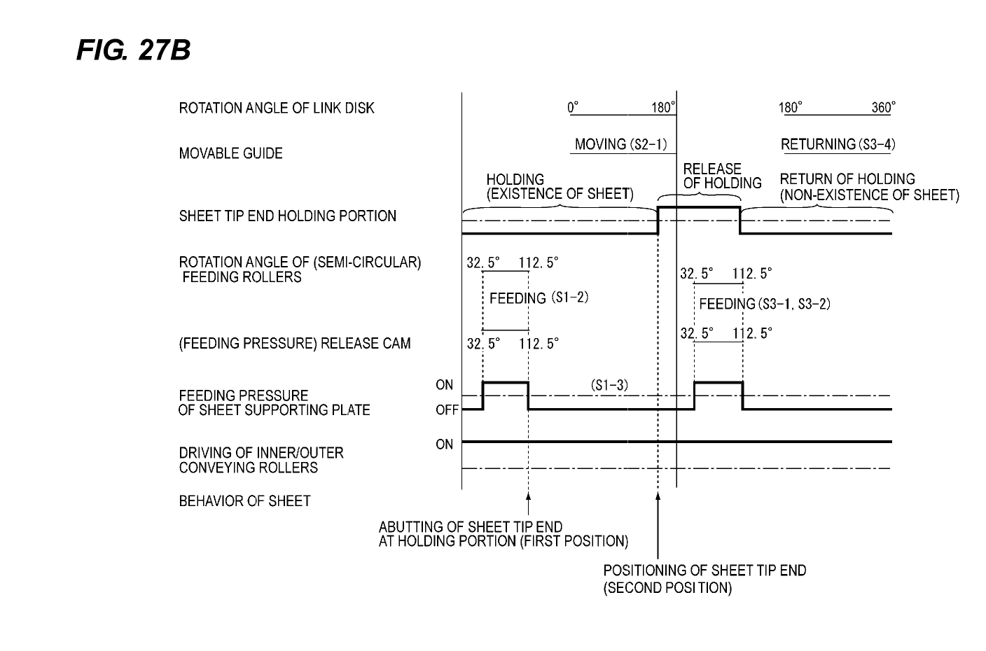

FIGS. 27A and 27B are a chart illustrating the operation timing of the main component of the sheet feeding device. In the embodiment, since one cycle ends by one revolution of the cam gear, each of the steps will be described so as to correspond to the rotation angle of the cam gear.

### <S1: Holding of Sheet Tip End (First Position) (Rotation of Cam Gear by 0 to 90°)>

### <S1-1: Triggering (Rotation of Cam Gear by 0 to 10°)>

In order to perform a feeding start operation, an operation signal is given to the solenoid 185. As illustrated in FIG. 19, the solenoid body 1851 and the trigger shaft 181 are supported by the body-shaft coupling portion 184 together. For this reason, when the solenoid body 1851 is suctioned, the trigger shaft 181 moves in the same direction (in the right direction) along with the solenoid body 1851. Since the trigger 182 (183) is supported along with the trigger shaft 181, the abutting surface 182a (183a) of the trigger 182 (183) moves in the same direction along with the movement of the solenoid body 1851. Then, the contact area of both abutting surfaces decreases as it goes away from the recessed abutting surface 152b (162b) of the trigger rod 152 (162). Then, when the contact area of both abutting surfaces completely disappears, the trigger rod 152 (162) is pressed forward by a rod spring (not illustrated) since the forward regulation by the trigger 182 (183) disappears.

The pressed trigger rod 152 (162) presses the trigger levers 1412 and 1413 through the trigger lever connection portion 1414 (see FIGS. 6 to 7C) which is integrated by connecting both trigger levers 1412 and 1413 through a screw. As illustrated in FIGS. 15 and 16, since the trigger lever 1412 (1413) may swing about the inner conveying roller shaft 1411, the trigger lever 1412 (1413) rotates in the clockwise direction when viewed from the left direction of the device.

When the trigger lever starts to rotate so that the trigger lever catch portion 1412a (1413a) contacts the cylindrical surface of one cam bit 132e (133e) of two cam bits 132e and 132f (133e and 133f) provided at the interval of 180° in the side surface of the cam gear 132 (133) in the circumferential direction, the cam gear starts to rotate. When the cam gear 132 (133) rotates by 10° from the standby position, the cam gear 132 (133) and the inner conveying roller gear 1415 (1416) engage with each other.

When the cam gear 132 (133) and the inner conveying roller gear 1415 (1416) engage with each other, the cam gear 132 (133) may receive the driving force from the main motor 31 through the inner conveying roller gear 1415 (1416).

At this time, the top ridge portion 132ca (133ca) of the mountain-shaped protrusion 132c (133c) of the side surface of the cam gear 132 (133) enters the flange edge 115a (116a) of the feeding gear 115 (116) while getting over the flange edge. For this reason, the position of the feeding gear 115 (116) in the thrust direction becomes closest to the frame 12, and the elongated groove portion 115b (116b) of the feeding gear fitted to the convex portion 117a (118a) of the link disk 117 (118) is completely separated from the link disk. For this reason, the rotation force of the feeding gear 115 (116) with respect to the link disk 117 (118) is completely interrupted.

### <S1-2: Feeding (Rotation of Cam Gear by 16.25 to 56.25°)>

### (Rotation of Feeding Roller by 32.5 to 112.5°)

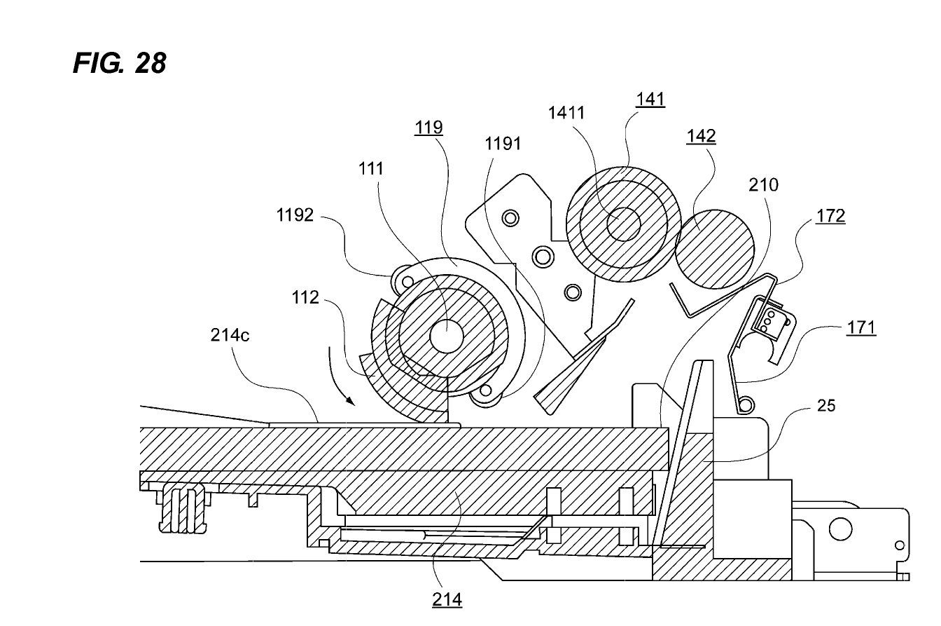

FIG. 28 is a diagram (a cross-sectional view) illustrating a state where the sheet feeding operation performed by the feeding rubber roller 112 starts when viewed from the right direction.

As illustrated in FIGS. 15 and 16, the catch portion 1412a (1413a) of the trigger lever 1412 (1413) contacts and presses the cylindrical surface of the cam bit 132e (133e), and hence the cam gear 132 (133) starts to rotate. Accordingly, the feeding gear 115 (116) also starts to rotate. Further, when the cam gear 132 (133) rotates by 10° from the standby position and engages with the inner conveying roller gear 1415 (1416), the feeding gear 115 (116) receives the driving force from the main motor 31.

As illustrated in FIG. 3, when the feeding gear 115 (116) starts to rotate, the feeding shaft 111 integrally coupled thereto and the release cam 119 (120) and the feeding rubber roller 112 integrally coupled to the feeding shaft 111 start to rotate at the same speed in the same direction.

As illustrated in FIG. 20, the sheet supporting plate 214 is pressed downward by the release cam 119 (120) at the standby position. However, the roller 1191 (1201) of the release cam 119 (120) is separated from the end 214c (214d) of the sheet supporting plate until the feeding rubber roller 112 rotates by 32.5°. Accordingly, the sheet supporting plate 214 moves upward by a compression spring (not illustrated), and the uppermost sheet 210 inside the cassette box 21 is pressed against the auxiliary rollers 113 (114) at both sides of the feeding rubber roller 112 by the sheet supporting plate 214.

The radius of the feeding rubber roller 112 is set to be slightly larger than that of the auxiliary roller 113 (114). For this reason, as illustrated in FIG. 28, when the feeding rubber roller 112 rotates by 32.5°, the semi-circular end of the feeding rubber roller 112 separates the uppermost sheet 210 inside the cassette box 21 from the auxiliary roller 113 (114) and contacts the uppermost sheet 210. Since a pressing force is generated between the feeding rubber roller 112 and the uppermost sheet 210, the sheet starts to be fed by the friction of the feeding rubber roller 112. This state is continued until the feeding rubber roller 112 rotates by 112.5°.

The slope separation portion 25 which is inclined with respect to the sheet traveling direction is provided at the downstream side of the feeding rubber roller 112. One sheet is separated when two or more sheets are fed. As illustrated in FIG. 29, one sheet that passes through the slope separation portion 25 enters the sheet tip end holding portion 172 so that the tip end abuts against the inside thereof.

### <S1-3: Releasing of Sheet Supporting Plate (Rotation of Cam Gear by 56.25 to 90°)>

### (Rotation of Feeding Roller by 112.5 to 180°)

FIG. 29 is a diagram (a cross-sectional view) illustrating a state where the sheet feeding operation performed by the feeding rubber roller 112 ends when viewed from the right direction. As illustrated in FIG. 29, the release cam 119 (120) rotates along with the feeding rubber roller 112 so that the roller 1192 (1202) rotates while contacting the end 214c (214d) of the sheet supporting plate and presses the sheet supporting plate 214 downward. As a result, the pressing force between the feeding rubber roller 112 and the uppermost sheet 210 is released. The pressing force is released until the cam gear 132 (133) rotates by 180°.

### <S2: Moving and Positioning of Sheet Tip End (First Position to Second Position) (Rotation of Cam Gear by 90 to 180°)>

### <S2-1: Moving of Movable Guide>

When the cam gear 132 (133) rotates by 90°, the feeding gear 115 (116) illustrated in FIG. 18 rotates by 180°. At this time, the elongated groove portion 115b (116b) of the feeding gear faces the convex portion 117a (118a) of the link disk 117 (118).

Simultaneously, the feeding gear 115 (116) is biased in the thrust direction of the feeding shaft 111 by the compression spring 321 (322) so that the flange edge 115a (116a) faces the bottom surface portion 132g (133g) as the mountain-shaped protrusion slope of the cam gear 132 (133). Accordingly, the feeding gear 115 (116) is movable to the bottom surface portion 132g (133g). As a result, the elongated groove portion 115b (116b) of the feeding gear 115 (116) is completely fitted to the convex portion 117a (118a) of the link disk 117 (118). For this reason, the mechanic clutch which is formed by the feeding gear 115 (116) and the link disk 117 (118) becomes an ON state. Accordingly, the rotation force of the feeding gear 115 (116) may be completely transmitted to the link disk 117 (118).

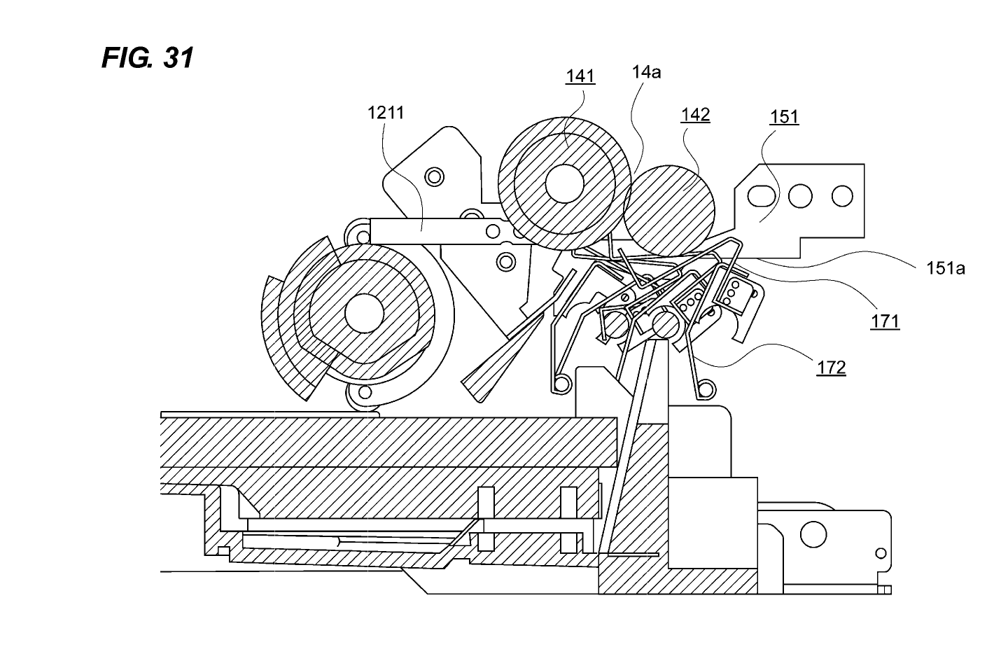

When the link disk 117 (118) illustrated in FIG. 21 starts to rotate, the movable guide 17 integrated with the guide shaft 173 starts to move in a direction from the first position to the second position by the crank mechanism formed by the link disk 117 (118) and the link 1001 (1002). As illustrated in FIGS. 25 and 26, the bar-shaped portion 171g (171h) of the movable guide plate 171 inclines the L-shaped arm 261 (271) to rotate the L-shaped arm, gets over the L-shaped arm, and reaches the second position. Further, as illustrated in FIG. 31, the movable guide plate 171 and the sheet tip end holding portion 172 move while changing the postures thereof so that the movable guide plate 171 and the sheet tip end holding portion 172 dive to the lower side of the outer conveying roller 142.

FIG. 30 is a diagram (a cross-sectional view) illustrating a state where the sheet tip end holding portion 172 is opened at the second position. When the movable guide 17 starts to move from the first position illustrated in FIG. 29 to the second position illustrated in FIG. 30, the sheet starts to be pressed back forward along with the movable guide 17 while the tip end abuts against the abutting portion 172b of the sheet tip end holding portion 172. Since the pressing force of the sheet supporting plate 214 is released and a minute gap is set between the backward pressed sheet and the left auxiliary roller 113 (the right auxiliary roller 114), the auxiliary roller 113 (114) becomes a stopper when the sheet is pressed back, and hence the sheet does not become slack.

### <S2-2: Releasing of Sheet Tip End Holding Portion>

As illustrated in FIG. 30, when the movable guide plate 171 moves from the first position to the second position along with the sheet tip end holding portion 172, the projection portion 172d (172e) of the sheet tip end holding portion 172 abuts against the front end 1211a (1221a) of the pressing cylinder in the vicinity of the second position. The biasing force of the sheet tip end holding portion 172 is set to be weaker than the biasing force of the pressing cylinder 1211 (1221). For this reason, when the movable guide plate 171 further moves forward, the sheet tip end holding portion 172 is opened in the clockwise direction against the biasing force of the sheet tip end holding portion 172 when viewed from the right direction.

Since the position of the front end of the pressing cylinder in the front to back direction, the compression spring pressure (at the timing of opening the sheet tip end holding portion 172), and the surface properties of the triangular pillar portion 123a of the inner guide 123 and the guide portion 172a of the sheet tip end holding portion 172 are adjusted, the sheet tip end holding portion 172 are opened. Further, the sheet tip end may be set to a stable position in the vicinity of the sheet tip end holding portion 172. This state corresponds to a state where the shutter for determining the position of the sheet tip end originally exists at the second position and the sheet tip end abuts against the shutter in a standby state.

When the cam gear 132 (133) rotates by 180°, the missing teeth portion 132b (133b) faces the inner conveying roller gear 1415 (1416). For this reason, the transmission of the driving force from the main motor 31 to the inner conveying roller gear 1415 (1416) is interrupted, and hence the feeding gear 115 (116), the feeding rubber roller 112, the release cam 119 (120), the link disk 117 (118), and the movable guide 17 are stopped.

The feeding gear 115 (116), the feeding rubber roller 112, and the release cam 119 (120) are located at the same position as that of the position of the standby state. The link disk 117 (118) is located at the position rotated by 180°. On the other hand, the inner conveying roller 141 and the outer conveying roller 142 integrated with the inner conveying roller gear 1415 (1416) continuously rotate.

### <S3: Perpendicular Conveying (Rotation of Cam Gear by 180 to 360°)>

### <S3-1: Conveying of Feeding Roller>

The driving signal for the solenoid 185 becomes an ON state again with respect to the sheet waiting at the second position in synchronization with the image forming operation. When the driving signal for the solenoid 185 becomes an ON state, the triggering action is performed in the same process as the section of “S1: Holding of Sheet Tip End (First Position)”, and the sheet waiting at the second position starts to be conveyed by the feeding rubber roller 112.

### <S3-2: Conveying by Combination of Feeding Rubber Roller 112 and Pair of Conveying Rollers 14>

As illustrated in FIG. 30, when the tip end of the sheet reaches the nip 14a of the pair of conveying rollers 14 while the sheet is regulated by the movable guide plate 171 and the inner guide 123 facing the movable guide plate, the sheet is conveyed by the pair of conveying rollers 14, and is pressed by the feeding rubber roller 112 from the rear side.

### <S3-3: Conveying of Pair of Conveying Rollers 14>

When the sheet tail end is supplied by the feeding rubber roller 112, the sheet is conveyed toward the downstream side only by the pair of conveying rollers 14.

### <S3-4: Returning of Movable Guide (Rotation of Cam Gear by 270 to 360°)>

### (Rotation of Feeding Roller by 180 to 360°)

FIG. 31 is a diagram (a cross-sectional view) illustrating a change in posture while the movable guide 17 moves in a reciprocating manner between the first position and the second position when viewed from the right direction.

The movable guide 17 may be moved in the same process as the section of “S2-1: Moving of Movable Guide”. When the link disk 117 (118) starts to rotate, the movable guide 17 moving along with the guide shaft 173 starts to move in a direction from the second position to the first position by the crank mechanism (see FIG. 22) formed by the link disk 117 (118) and the link 1001 (1002). At this time, the movable guide plate 171 and the sheet tip end holding portion 172 are inclined and sent by the movable guide posture changing unit 26 (27).

When the cam gear 132 (133) rotates by 360°, the missing teeth portion 132a (133a) faces the inner conveying roller gear 1415 (1416) as illustrated in FIG. 15 (FIG. 16). For this reason, the transmission of the driving force from the main motor 31 to the inner conveying roller gear 1415 (1416) is interrupted, and hence the feeding gear 115 (116), the feeding rubber roller 112, the release cam 119 (120), and the link disk 117 (118) are stopped. All components return to the position of the standby state, and hence the next sheet may be fed.

Here, the effect of the embodiment will be described. FIG. 32 is a diagram illustrating a state where the route of the sheet conveying path is changed to the inside of the apparatus compared to the related art after the sheet is picked up. A sheet conveying path 2100 of the embodiment indicates the conveying path in which the tip end of the pick-up sheet moves from the first position to the second position and the sheet is conveyed by the pair of conveying rollers 14. A sheet conveying path 2101 indicates a sheet conveying path in which the sheet tip end is continuously fed by the feeding rubber roller 112 from the first position as in the related art. A conveying roller 2102 is one of the conveying portions in the case of the sheet conveying path 2101.

According to the embodiment, the sheet conveying path 2100 may be set to the inside of the apparatus by the amount ΔD while including the conveying portion compared to the sheet conveying path 2101. For this reason, the installation space of the device may be decreased by the same amount (ΔD) since the maximum outer side at the feeding side in the sheet feeding direction may be changed from the position a1 of the related art to the position a2.

Further, according to the embodiment, the sheet supporting plate 214 of the pressing unit is operated only when the sheet is fed by the feeding rubber roller 112, and the pressing unit is immediately released after the feeding operation ends. For this reason, the sheet feeding amount may be set in consideration of a degradation in durability of the feeding rubber roller 112 (as an extra amount) and a change in feeding amount caused by the sheet stacking state (a small stacking amount to a full stacking amount).

Accordingly, the sheet tip end may reliably abut against the abutting portion 172b of the sheet tip end holding portion 172 regardless of the sheet stacking state (a small stacking amount to a full stacking amount) and degradation in durability of the feeding rubber roller 112. As a result, it is possible to improve the positional precision of the sheet tip end when the sheet tip end holding portion 172 is opened at the second position. At this time, the extra sheet feeding amount of the feeding rubber roller 112 forms a loop (a slack portion) for a time. However, since the sheet supporting plate 214 is released immediately after the feeding operation ends, the loop is also opened immediately.

Further, since the sheet supporting plate 214 is released even when the movable guide 17 moves from the first position to the second position, a new loop is not formed. Thus, a problem such as an increase in driving load of the movable guide 17 and an increase in holding force of the sheet tip end holding portion 172 does not arise.

When the pressing unit is not opened differently from the embodiment, the extra sheet feeding amount may not be set only in a degree that the movement of the movable guide 17 is not disturbed, and may not be sufficiently set in consideration of the sheet stacking state (a small stacking amount to a full stacking amount) and a degradation in durability of the feeding rubber roller 112. Accordingly, the sheet tip end may not easily abut against the abutting portion 172b of the sheet tip end holding portion 172, and hence the positional precision of the sheet tip end when the sheet tip end holding portion 172 is opened at the second position is degraded compared to the embodiment.

Further, according to the embodiment, the switch portion serves as the holding release portion which cancels the sheet tip end holding function by pressing the projection portion 172d (172e) of the sheet tip end holding portion 172 when the sheet tip end holding portion 172 moves from the first position to the second position. Further, the switch portion serves as the return portion which returns the posture of the sheet tip end holding portion 172 by including the pressing cylinder 1211 (1221) which enables the holding function while releasing the pressing state of the projection portion 172d (172e) of the sheet tip end holding portion 172 when the sheet tip end holding portion 172 moves from the second position to the first position. Accordingly, since there is no need to provide a solenoid as an electric actuator as the switch portion, the device may be decreased in dimension and cost.

Further, according to the embodiment, when the sheet tip end holding portion 172 and the movable guide plate 171 move between the first position and the second position in a reciprocating manner, the sheet tip end holding portion 172 and the movable guide plate 171 are inclined so as to dive to the lower side of the outer conveying roller 142. When the sheet tip end holding portion 172 and the movable guide plate 171 are not inclined, the position of the outer conveying roller 142 may be set to the upside compared to the embodiment so that the outer conveying roller does not contact the sheet tip end holding portion 172 and the movable guide plate 171 in the movement state. Accordingly, the device may be further decreased in dimension in the height direction compared to a case where the sheet tip end holding portion 172 and the movable guide plate 171 are not inclined.

Further, according to the embodiment, one motor 31 is used as the rotational driving source for moving the system, and one solenoid 185 is used for the triggering action when the operation starts. Even in the configuration in which the rotational driving sources for the feeding roller 11, the release cam 119 (120), the movable guide 17, and the pair of conveying rollers 14 are separately provided, a continuous operation may be performed as in the embodiment. However, the device increases in size and cost. Accordingly, in the case of the embodiment, the sheet tip end holding portion 172 or the movable guide plate 171 is driven by the same driving source. For this reason, the device may be decreased in dimension and cost compared to a case where the rotational driving source is independently provided.

Further, in an image forming apparatus (of a color electrophotographic system) including the sheet feeding device of the embodiment, there is no need to provide a registration roller, a sensor, and a shutter member for adjusting the feeding timing mentioned in Japanese Patent Laid-Open No. 2010-210797 of Patent Document 1. For this reason, the device may be decreased in dimension in the height direction and may be decreased in cost in addition to a decrease in installation space of the device.

A color electrophotographic system has been exemplified as the image forming apparatus including the sheet feeding device of the embodiment, but the invention may be also applied to the other image forming apparatus of a black electrophotographic system or an inkjet scheme.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-088232, filed Apr. 22, 2014, which is hereby incorporated by reference herein in its entirety.

What is claimed is:

1. A sheet feeding device comprising:
a feeding portion configured to feed sheets stacked on a stacking portion;
a separation portion configured to separate the sheets fed by the feeding portion one by one;
a tip end holding portion configured to hold a tip end of the sheet fed by the feeding portion at a first position on the downstream side in the sheet feeding direction in relation to the separation portion;
a guide portion configured to guide the sheet fed by the feeding portion;
a movement unit configured to move the tip end holding portion and the guide portion between the first position and a second position closer to the feeding portion in relation to the first position;
a holding release portion configured to release the sheet held by the tip end holding portion that holds the sheet tip end when the tip end holding portion moves from the first position to the second position; and
a conveying portion configured to convey the sheet released from the tip end holding portion at the second position and fed by the feeding portion and convey the sheet in an area near the feeding portion in relation to the first position.

2. The sheet feeding device according to claim 1,
wherein the conveying portion conveys the sheet in a direction substantially perpendicular to the sheet feeding direction of the feeding portion.

3. The sheet feeding device according to claim 1, further comprising:
a pressing portion configured to press the sheets stacked on the stacking portion against the feeding portion; and
a pressing release portion configured to release a state where the pressing portion presses the sheets against the feeding portion when the tip end holding portion and the guide portion move from the first position to the second position.

4. The sheet feeding device according to claim 1,
wherein the holding release portion releases a state where the tip end holding portion holds the sheet by rotating the tip end holding portion while pressing the tip end holding portion when the tip end holding portion moves from the first position to the second position.

5. The sheet feeding device according to claim 3,
wherein the holding release portion releases a state where the tip end holding portion holds the sheet by rotating the tip end holding portion while pressing the tip end holding portion when the tip end holding portion moves from the first position to the second position.

6. The sheet feeding device according to claim 1, further comprising:
a return portion configured to return the posture of the tip end holding portion when the tip end holding portion moves from the second position to the first position.

7. The sheet feeding device according to claim 3, further comprising:
a return portion configured to return the posture of the tip end holding portion when the tip end holding portion moves from the second position to the first position.

8. The sheet feeding device according to claim 4, further comprising:
a return portion configured to return the posture of the tip end holding portion when the tip end holding portion moves from the second position to the first position.

9. The sheet feeding device according to claim 1, further comprising:
a posture changing unit configured to change the postures of the tip end holding portion and the guide portion so that the tip end holding portion and the guide portion do not contact the conveying portion when the tip end holding portion and the guide portion move between the first position and the second position.

10. The sheet feeding device according to claim 4, further comprising:
a posture changing unit configured to change the postures of the tip end holding portion and the guide portion so that the tip end holding portion and the guide portion do not contact the conveying portion when the tip end holding portion and the guide portion move between the first position and the second position.

11. The sheet feeding device according to claim 6, further comprising:
a posture changing unit configured to change the postures of the tip end holding portion and the guide portion so that the tip end holding portion and the guide portion do not contact the conveying portion when the tip end holding portion and the guide portion move between the first position and the second position.

12. The sheet feeding device according to claim 1,
wherein the movement unit moves the tip end holding portion and the guide portion by the same driving source.

13. The sheet feeding device according to claim 3,
wherein the movement unit moves the tip end holding portion and the guide portion by the same driving source.

14. An image forming apparatus comprising:
the sheet feeding device according to claim 1; and
an image forming portion configured to form an image on a sheet fed by the sheet feeding device.

15. The image forming apparatus according to claim 14,
wherein the conveying portion conveys the sheet in a direction substantially perpendicular to the sheet feeding direction of the feeding portion.

16. The image forming apparatus according to claim 14, further comprising:
a pressing portion configured to press the sheets stacked on the stacking portion against the feeding portion; and
a pressing release portion configured to release a state where the pressing portion presses the sheets against the feeding portion when the tip end holding portion and the guide portion move from the first position to the second position.

17. The image forming apparatus according to claim 14,
wherein the holding release portion releases a state where the tip end holding portion holds the sheet by rotating the tip end holding portion while pressing the tip end holding portion when the tip end holding portion moves from the first position to the second position.

18. The image forming apparatus according to claim 14, further comprising:
a return portion configured to return the posture of the tip end holding portion when the tip end holding portion moves from the second position to the first position.

19. The image forming apparatus according to claim 14, further comprising:
a posture changing unit configured to change the postures of the tip end holding portion and the guide portion so that the tip end holding portion and the guide portion do not contact the conveying portion when the tip end holding portion and the guide portion move between the first position and the second position.

20. The image forming apparatus according to claim 14,
wherein the movement unit moves the tip end holding portion and the guide portion by the same driving source.
